(19) United States
(12) Patent Application Publication
(10) Pub. No.: US 2024/0249325 A1
(43) Pub. Date: Jul. 25, 2024

(54) SYSTEM AND METHOD FOR GENERATION OF COMPLIANCE NOTIIFICATION FOR VEHICLE TRANSACTION

(71) Applicant: Honda Motor Co., Ltd., Tokyo (JP)

(72) Inventor: MATT KOMICH, Denver, CO (US)

(21) Appl. No.: 18/157,745

(22) Filed: Jan. 20, 2023

(51) Int. Cl. G06Q 30/0601; G06Q 50/30

(52) U.S. Cl. CPC G06Q 30/0609; G06Q 30/0633; G06Q 50/30

(57) ABSTRACT

An electronic device is disclosed. The electronic device includes memory to store a neural network model which has been trained with regulation information for a plurality of vehicles at a plurality of geolocations. The electronic device further includes a processor to receive first information from a buyer device, which corresponds to a vehicle to be purchased for a first geolocation of the buyer device. The processor further receives, from a seller device, second information which corresponds to a set of features of the vehicle. The processor applies the neural network model on the first information and the second information to determine whether the set of features of the vehicle complies with the regulation information for the vehicle at the first geolocation. Based on the determination, the processor generates a notification and controls an output device to render the generated notification.

### BACKGROUND

Vehicle transactions (such as transactions related to a purchase of a vehicle) may generally occur between a buyer and a seller. In such instances, a plurality of sellers may list available vehicles for purchase in an application, for example, via software installed on an electronic device, such as, a smart phone. The buyer may typically search for requirements of the vehicle from a plurality of sellers listed in the application, via an electronic device (for example, a mobile phone) of the buyer. Based on the requirements of the buyer, the seller may be selected from the plurality of sellers and a communication associated with the vehicle transaction may be initiated.

In certain instances, the communication between the buyer and the seller may lead to a successful vehicle transaction (i.e., a transfer of ownership from the seller to the buyer). In some situations, the communication between the buyer and the seller may be dropped because of a difficulty in understanding the purchase requirements of the buyer and/or the seller. This may lead to a loss in time for the buyer and/or the seller. In certain situations, due to unavailability of detailed information about the vehicle, the seller or the buyer may face challenges during or after the vehicle transaction.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to an embodiment of the disclosure, an electronic device for vehicle transaction is disclosed. The electronic device may include memory to store a neural network model which has been trained with regulation information for a plurality of vehicles at a plurality of geolocations. The regulation information may correspond to a requirement of each of a plurality of features of the plurality of vehicles to operate in one or more geolocations of the plurality of geolocations. The electronic device may further include at least one processor to receive first information from a buyer device. The first information may correspond to a vehicle to be purchased for a first geolocation of the buyer device.

The processor may further receive second information from a seller device. The second information may correspond to a set of features of the vehicle to be sold by a seller of the seller device, such that, a second geolocation of the seller device and the vehicle may be different from the first geolocation. The processor may apply the trained neural network model on the received first information and the second information to determine whether the set of features of the vehicle complies with the requirement of the vehicle for the first geolocation of the buyer device. The processor may generate a notification based on the application of the neural network model. The generated notification may indicate the requirement for at least one of the set of features for the first geolocation. The processor may control an output device to render the generated notification.

According to another embodiment of the disclosure, a seller device for vehicle transaction is disclosed. The seller device may include memory to store a neural network model which has been trained with regulation information for a plurality of vehicles at a plurality of geolocations. The regulation information may correspond to a requirement of each of a plurality of features of the plurality of vehicles to operate in one or more geolocations of the plurality of geolocations. The seller device may further include at least one processor to receive first information from a plurality of buyer devices. The first information may correspond to a vehicle to be purchased for a plurality of geolocations of the plurality of buyer devices. The processor may acquire second information from the seller device. The second information may correspond to a set of features of the vehicle to be sold by a seller of the seller device, such that, a second geolocation of the seller device and the vehicle may be different from the plurality of geolocations of the plurality of buyer devices. The processor may apply the trained neural network model on the received first information and the acquired second information to determine whether the set of features of the vehicle complies with the requirement of the vehicle for the plurality of geolocations of the plurality of buyer devices. The processor may generate a seller notification based on the application of the neural network model. The generated seller notification may indicate the requirement for at least one of the set of features for each of the plurality of geolocations related to corresponding buyer device of the plurality of buyer devices. The processor may control an output device to render the generated notification.

According to another embodiment of the disclosure, a buyer device for a vehicle transaction is disclosed. The buyer device may include memory to store a neural network model which has been trained with regulation information for a plurality of vehicles at a plurality of geolocations. The regulation information may correspond to a requirement of each of a plurality of features of the plurality of vehicles to operate in one or more geolocations of the plurality of geolocations. The buyer device may further include at least one processor to acquire first information from the buyer device. The first information may correspond to a vehicle to be purchased for a first geolocation of the buyer device. The processor may receive second information from a plurality of seller devices. The second information may correspond to a set of features of each of a set of vehicles to be sold by a plurality of sellers related to the plurality of seller devices, such that, geolocations of the plurality of seller devices and the set of vehicles are different from the first geolocation. The processor may apply the trained neural network model on the acquired first information and the received second information to determine whether the set of features of the vehicle complies with the requirement of the vehicle for the first geolocation of the buyer device. The processor may generate a buyer notification based on the application of the neural network model. The generated notification may indicate the requirement for at least one of the set of features for the first geolocation. The processor may control an output device to render the generated notification.

According to another embodiment of the disclosure, a method for vehicle transaction is disclosed. The method may include storing of a neural network model which has been trained with regulation information for a plurality of vehicles at a plurality of geolocations. The regulation information may correspond to a requirement of each of a plurality of features of the plurality of vehicles to operate in one or more geolocations of the plurality of geolocations. The method may further include receiving first information from a buyer device. The first information may correspond to a vehicle to be purchased for a first geolocation of the buyer device. The method may further include receiving second information from a seller device. The second information may correspond to a set of features of the vehicle to be sold by a seller of the seller device, such that, a second geolocation of the seller device and the vehicle may be different from the first geolocation. The method may further include applying the trained neural network model on the received first information and the second information to determine whether the set of features of the vehicle complies with the requirement of the vehicle for the first geolocation of the buyer device. The method may further include generating a notification based on the application of the neural network model. The generated notification may indicate the requirement for at least one of the set of features for the first geolocation. The method may further include controlling an output device to render the generated notification.

### BRIEF DESCRIPTION OF THE DRAWINGS

FIG. 1 is a block diagram that illustrates an exemplary network environment for a vehicle transaction, in accordance with an embodiment of the disclosure.

FIG. 2 is a block diagram that illustrates an exemplary electronic device shown in the exemplary network environment of FIG. 1, in accordance with an embodiment of the disclosure.

FIGS. 3A-3C are diagrams that illustrate an exemplary execution pipeline to perform a vehicle transaction, via an electronic device, in accordance with an embodiment of the disclosure.

FIG. 4 is a diagram that illustrates an exemplary execution pipeline to perform a vehicle transaction, via a buyer device, in accordance with an embodiment of the disclosure.

FIG. 5 is a diagram that illustrates an exemplary execution pipeline to perform a vehicle transaction, via a seller device, in accordance with an embodiment of the disclosure.

FIG. 6 is a flowchart that illustrates exemplary operations to perform a vehicle transactions, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The following described implementations may be found in a disclosed electronic device and a method to perform vehicle transaction between a buyer device and a seller device. The electronic device (for example, a server) may include a memory that may be configured to store a neural network model (or an artificial intelligent engine) which has been trained with regulation information for a plurality of vehicles located at a plurality of geolocations. The regulation information may correspond to a requirement of each of a plurality of features of the plurality of vehicles to operate in one or more geolocations of the plurality of geolocations. The plurality of features may include a structural feature (like a part of the vehicle) or a functional feature of the vehicle. Therefore, using the regulation information, the trained neural network model is aware about different requirements of various features of the vehicles to operate the vehicles in any geolocation of the plurality of geolocations.

The electronic device may be configured to receive first information from a buyer device (for example, a mobile phone of a buyer). The first information may correspond to a vehicle. The first information may further relate to a type of the vehicle such as an electric vehicle, a hybrid vehicle or a gas-fueled vehicle. The first information may also relate to a specific feature (like a spoiler attachment, a turbo attachment, an additional fuel-related component or the like) of the vehicle The first information may be received for the vehicle to be purchased for a first geolocation (a particular city, state, province, or country) of the buyer device. Based on reception of the first information, the electronic device may determine, via the neural network model, whether the vehicle (to be purchased) complies with the requirement (stored in the electronic device) for the first geolocation of the buyer device or not. Based on the determination, the electronic device may generate a notification indicating whether the vehicle (to be purchased) is compliant with the requirement for the first geolocation of the buyer device, or not.

The electronic device may be further configured to receive second information from a seller device (for example, a mobile phone of a seller) associated with the vehicle to be sold to the buyer associated with the buyer device. The second information may correspond to a set of features of the vehicle to be sold by the seller of the seller device that may be located at a second geolocation which may be different from the first geolocation of the buyer device. The electronic device may further apply the trained neural network model on the received first information and the second information to determine whether the set of features of the vehicle (to be sold) complies with the requirement of the vehicle for the first geolocation of the buyer device. In an example, in case of gas fueled vehicles, the first geolocation may have a requirement of an emission test certification for such gas-fueled vehicle to operate at the first geolocation of the buyer device. Therefore, the electronic device may determine, via the trained neural network model, whether the gas-fueled vehicle (to be sold by the seller) complies with the requirement (i.e., the emission test certification) of the vehicle for the first geolocation of the buyer device. In another example, if the first geolocation has a requirement that allows only electric vehicles to be operated in the first geolocation, the electronic device may apply the trained neural network model on the second information to determine whether the set of features of the vehicle (to be sold) complies with the requirement (i.e., the electric vehicle requirement) of the vehicle for the first geolocation of the buyer device.

The electronic device may further generate the notification that may indicate whether the vehicle (to be sold) complies with the requirement of the vehicle for the first geolocation or not. The generated notification may be rendered as an alert to the seller and/or to the buyer that may indicate whether the vehicle of the seller (at the second geolocation) complies with the requirement of the vehicle to operate in the first geolocation of the buyer or not. Therefore, during the vehicle transaction (i.e., a sale/purchase of the vehicle) via the electronic device (like a server), the buyer and/or the seller may be well aware whether the vehicle at the second geolocation (such as a particular state, from where the vehicle has to be sold) complies with the requirement of the vehicle to be operated at the first geolocation (such as another state, for which the vehicle has to be purchased).

In an embodiment, the trained neural network model may be stored in a buyer device to receive information from a plurality of seller devices related to different sellers of vehicles. The buyer device, using the trained neural network model, may select a seller device (or seller of the vehicle) whose vehicle may comply with the requirement of the vehicle to be operated for a geolocation (such as the first geolocation) of the buyer device. In some embodiments, the trained neural network model may be stored in a seller device to receive information from a plurality of buyer devices related to different geolocations and different requirements. The seller device, using the trained neural network model, may select a buyer device (or buyer) where the vehicle (to be sold by the seller device) comply with the requirement for the geolocation (such as the first geolocation) of the selected buyer device.

Reference will now be made in detail to specific aspects or features, examples of which are illustrated in the accompanying drawings. Wherever possible, corresponding, or similar reference numbers will be used throughout the drawings to refer to the same or corresponding parts.

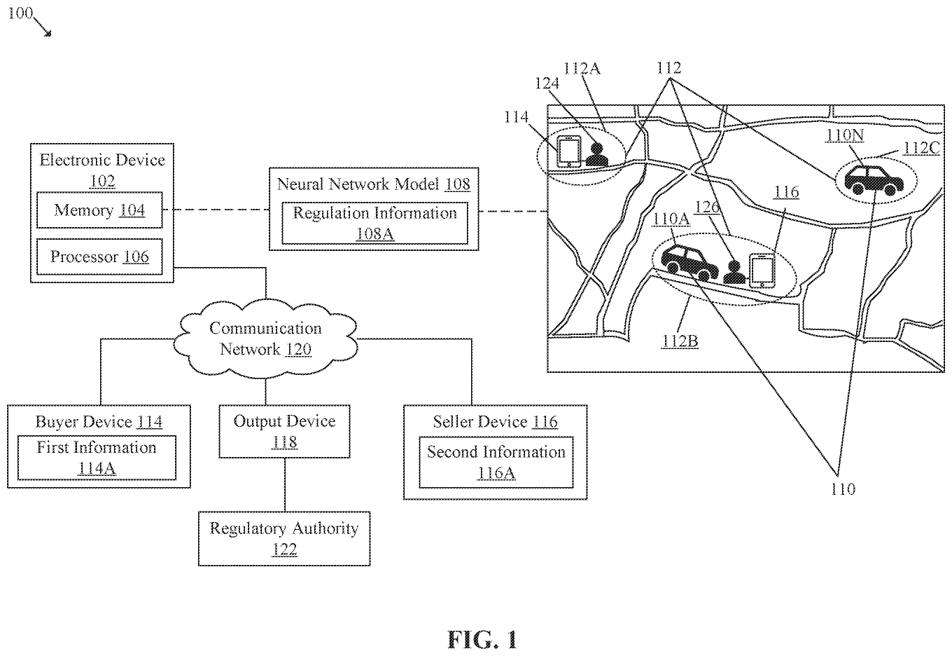

FIG. 1 is a block diagram that illustrates an exemplary network environment for a vehicle transaction, in accordance with an embodiment of the disclosure. With reference to FIG. 1, there is shown a network environment 100. The network environment 100 may include an electronic device 102. The electronic device 102 may include a memory 104 and a processor 106. The memory 104 may be configured to store a neural network model 108, which may be trained with regulation information 108A for a plurality of vehicles 110 at a plurality of geolocations 112. The electronic device 102 may be communicably coupled with a buyer device 114, a seller device 116, and an output device 118, via a communication network 120. In some situations, the electronic device 102 may also communicate with a regulatory authority 122, via the communication network 120.

The electronic device 102 may include suitable logic, circuitry, interfaces, and/or code that may be configured to be store, via the memory 104, the neural network model 108 trained based on the regulation information 108A for the plurality of vehicles 110 at the plurality of geolocations 112. The regulation information 108A may correspond to a requirement of each of a plurality of features of the plurality of vehicles 110 to operate in one or more geolocations of the plurality of geolocations 112. Therefore, if there is a need to validate a requirement (or compliance) to operate the vehicle in any geolocation of the plurality of geolocations 112, it may be directly retrieved as the regulation information 108A from the memory 104.

The electronic device 102 may be communicably coupled with the buyer device 114, the seller device 116, the output device 118, and the regulatory authority 122, via the communication network 120. In an embodiment, the electronic device 102 may be configured to receive first information 114A from the buyer device 114. The first information 114A may correspond to a first vehicle 110A (for example, a structural feature of the first vehicle 110A or a functional feature of the first vehicle 110A) from the plurality of vehicles 110. In an embodiment, the first vehicle 110A may be of buyer's interest, where a buyer 124 may be intending to purchase the first vehicle 110A for a first geolocation 112A (which may be associated with the buyer 124), via the buyer device 114 and the electronic device 102.

The electronic device 102 may be further configured to receive second information 116A from the seller device 116 of a seller 126. The second information 116A may correspond to a set of features of the first vehicle 110A to be sold by the seller 126 of the seller device 116 which may be located at a second geolocation 112B of the seller device 116, where the second geolocation 112B may be different from the first geolocation 112A. The electronic device 102 may be further configured to apply the trained neural network model 108 on the received first information 114A and the second information 116A to determine whether the set of features of the first vehicle 110A complies with the requirement of the first vehicle 110A for the first geolocation 112A of the buyer device 114. Based on the application of the neural network model 108, the electronic device 102 may be further configured to generate a notification and control the output device 118 to render (such as, via a display) the generated notification. Based on the notification, the buyer device 114 and/or the seller device 116 may be notified of any requirement (such as compliance requirements of the first geolocation 112A) in a purchase of the first vehicle 110A and may further avoid a loss in time that may incur in a communication between the buyer 124 and the seller 126, who does not meet the requirement for the purchase of the first vehicle 110A.

In an embodiment, the electronic device 102 may be a server. The server may include suitable logic, circuitry, and interfaces, and/or code that may be configured to communicably coupled with the buyer device 114, the seller device 116, the output device 118, and the regulatory authority 122, via the communication network 120. The server may be implemented as a cloud server and may execute operations through web applications, cloud applications, HTTP requests, repository operations, file transfer, and the like. Other example implementations of the server may include, but are not limited to, a database server, a file server, a web server, a media server, an application server, a mainframe server, or a cloud computing server. In at least one embodiment, the server may be implemented as a plurality of distributed cloud-based resources by use of several technologies that are well known to those ordinarily skilled in the art. A person with ordinary skill in the art may understand that the scope of the disclosure may not be limited to the implementation of the server in its entirety or at least partially in the electronic device 102. In certain embodiments, the functionalities of the server may be incorporated as a supplementary entity in addition to the electronic device 102, without a departure from the scope of the disclosure. Other examples of the electronic device 102 may include, but are not limited to, a computing device, a desktop, a personal computer, a laptop, a computer workstation, a tablet computing device, a smartphone, a cellular phone, a mobile phone, a consumer electronic (CE) device having a display, a wearable display, or an edge device connected to a buyer's home network or a seller's home network.

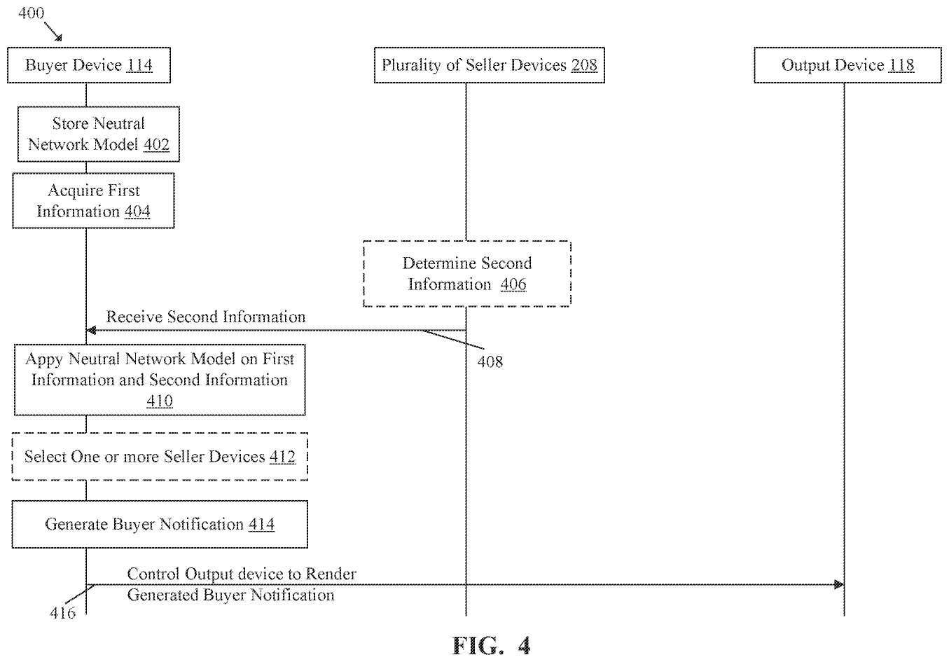

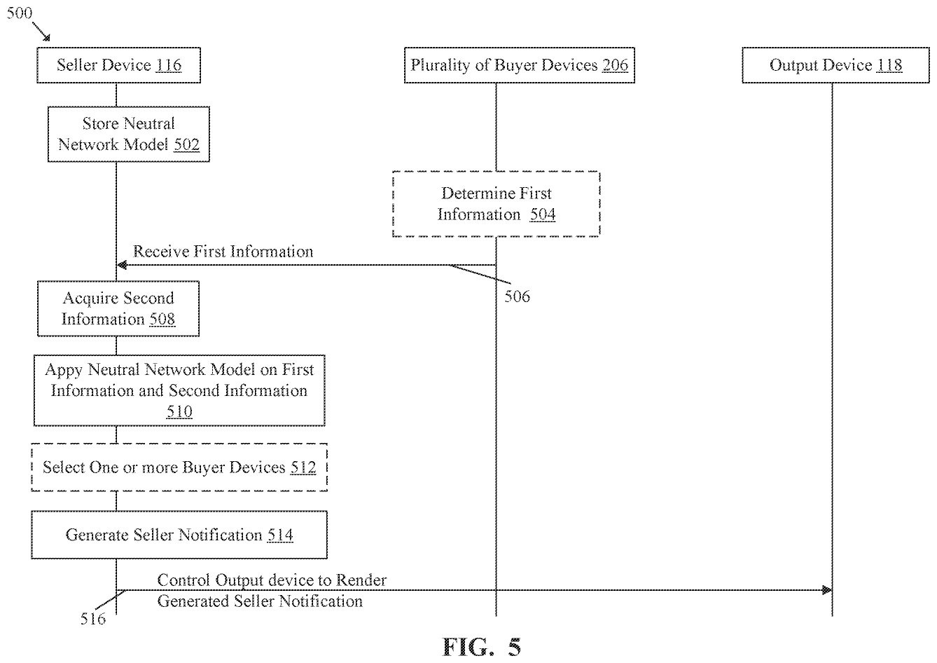

The memory 104 may include suitable logic, circuitry, interfaces, and/or code that may be configured to store the program instructions executable by the processor 106. In at least one embodiment, the memory 104 may be further configured to store the neural network model 108 trained based on the regulation information for the plurality of vehicles 110 at the plurality of geolocations 112. The memory 104 may be further configured to store the first information 114A that may be received from the buyer device 114. The memory 104 may be further configured to store the second information 116A that may be received from the seller device 116. The memory 104 may be further configured to store the generated notification for the output device 118. The memory 104 may be further configured to store third information (as described in FIG. 5) that may be received from a plurality of buyer devices (such as the buyer device 114). The memory 104 may be further configured to store fourth information (as described in FIG. 4) that may be received from a plurality of seller devices (such as the seller device 116). Example implementations of the memory 104 may include, but are not limited to, Random Access Memory (RAM), Read Only Memory (ROM), Hard Disk Drive (HDD), a Solid-State Drive (SSD), a CPU cache, and/or a Secure Digital (SD) card.

The processor 106 may include suitable logic, circuitry, and/or interfaces code that may be configured to execute program instructions associated with different operations to be executed by the electronic device 102. For example, some of the operations may include: storage of the neural network model 108 trained based on regulation information for the plurality of vehicles 110 at the plurality of geolocations 112, reception of the first information 114A from the buyer device 114, reception of the second information 116A from the seller device 116, application of the trained neural network model 108 on the received first information 114A and the second information 116A, generation-of the notification based on the application of the neural network model 108, and control of the output device 118 to render the generated notification.

The processor 106 may include any suitable special-purpose or general-purpose computer, computing entity, or processing device including various computer hardware or software modules and may be configured to execute instructions stored on any applicable computer-readable storage media. For example, the processor 106 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. The processor 106 may include any number of processors configured to, individually or collectively, perform or direct performance of any number of operations of the electronic device 102, the buyer device 114, the seller device 116 or the output device 118, as described in the present disclosure. Examples of the processor may include a Central Processing Unit (CPU), a Graphical Processing Unit (GPU), an x86-based processor, an x64-based processor, a Reduced Instruction Set Computing (RISC) processor, a Complex Instruction Set Computing (CISC) processor, and/or other hardware processors.

The neural network model 108 may be configured to receive instructions from the processor 106 and execute operations based on the received instructions. For example, the operations may include a comparison of the first information 114A (such as information about a vehicle to be purchased or about geolocation for which the vehicle has to be purchased) and the second information 116A (such as the set of features of the vehicle to be sold), with the stored regulation information 108A of the plurality of vehicles 110 to determine whether the set of features of the vehicle (such as the first vehicle 110A) complies with the requirement of the vehicle to be operated for the first geolocation of the buyer device, In an example, the neural network model 108 may include a computational network or a system of artificial neurons, arranged in a plurality of layers, as nodes. The plurality of layers of the neural network model 108 may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network model 108. Outputs of each hidden layer may be coupled to inputs of at least one node in other layers of the neural network model 108. Node(s) in the final layer may receive inputs from at least one hidden layer to output a result. The number of layers and the number of nodes in each layer may be determined from hyper-parameters of the neural network model 108. Such hyper-parameters may be set before or while training the neural network model 108 on a training dataset, which may include regulation information 108A of millions of features associated with each vehicle (such as the first vehicle 110A) of the plurality of vehicles 110.

Each node of the neural network model 108 may correspond to a mathematical function (e.g., a sigmoid function or a rectified linear unit) with a set of parameters, tunable during training of the neural network model 108. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network model 108 may correspond to same or a different same mathematical function.

In training of the neural network model 108, one or more parameters of each node of the neural network model 108 may be updated based on whether an output of the final layer for a given input (from the training dataset) matches a correct result based on a loss function for the neural network model 108. The above process may be repeated for same or a different input till a minima of loss function may be achieved, and a training error may be minimized. Several methods for training are known in art, for example, gradient descent, stochastic gradient descent, batch gradient descent, gradient boost, meta-heuristics, and the like.

The neural network model 108 may include electronic data, such as, for example, a software program, code of the software program, libraries, applications, scripts, or other logic or instructions for execution by a processing device, such as the processor 106. The neural network model 108 may include code and routines configured to enable a computing device, such as the processor 106 to perform one or more operations for classification of one or more inputs into the regulation that may be associated with each feature of corresponding vehicle (such as the first vehicle 110A) in the plurality of vehicles 110. Additionally, the neural network model 108 may be implemented using hardware including a processor, a microprocessor (e.g., to perform or control performance of one or more operations), a field-programmable gate array (FPGA), or an application-specific integrated circuit (ASIC). Alternatively, in some embodiments, the neural network may be implemented using a combination of hardware and software.

Examples of the neural network model 108 may include, but are not limited to, a deep neural network (DNN), a convolutional neural network (CNN), a recurrent neural network (RNN), a CNN-recurrent neural network (CNN-RNN), R-CNN, Fast R-CNN, Faster R-CNN, an artificial neural network (ANN), (You Only Look Once) YOLO network, a Long Short Term Memory (LSTM) network based RNN, CNN+ANN, LSTM+ANN, a gated recurrent unit (GRU)-based RNN, a fully connected neural network, a Connectionist Temporal Classification (CTC) based RNN, a deep Bayesian neural network, a Generative Adversarial Network (GAN), and/or a combination of such networks. In some embodiments, the neural network model 108 may include numerical computation techniques using data flow graphs. In certain embodiments, the neural network model 108 may be based on a hybrid architecture of multiple Deep Neural Networks (DNNs), which may be configured to determine whether the set of features of the first vehicle 110A complies with the requirement (i.e., the regulation information 108A) for the first vehicle 110A at the first geolocation 112A of the buyer device 114.

The regulation information 108A may correspond to millions of features associated with each vehicle (such as the first vehicle 110A) of the plurality of vehicles 110. In some situations, the regulation information 108A may include compliance related instructions to operate a vehicle (such as the first vehicle 110A) in a specific geolocation (such as the first geolocation 112A) of the buyer device 114. In some other situations, the regulation information 108A may include instructions to operate a vehicle with a specific feature, which may include one or more features of the millions of features, for example, a structural feature requirement of the vehicle, or a functional feature requirement of the vehicle, in a specific geolocation (such as the first geolocation 112A) of the buyer device 114. In an embodiment, the structural feature requirement may indicate changes allowed in a structural configuration of the vehicle, for example, a turbo attachment, a spoiler attachment, or a fuel-type of the vehicle, for each vehicle of the plurality of vehicles 110, which may be required for the vehicle to operate in the first geolocation 112A of the buyer device 114. In another embodiment, the functional feature requirement may indicate changes in a functional configuration of the vehicle, for example, a licensing or purchase requirement, a speed limit requirement, etc.), for each vehicle of the plurality of vehicles 110, which may be required for the vehicle to operate in the first geolocation 112A of the buyer device 114. In other situations, in addition to information associated with the features of the plurality of vehicles 110, the regulation information 108A may also include limitation and/or regulations for a purchase of the vehicle, based on at least one of: a buyer profile (such as a criminal record of the buyer, a purchase history of the buyer, etc.), or a seller profile (such as, a criminal record of the seller, a selling history of the seller, etc.).

The plurality of vehicles 110 may be a group of vehicles, such as, a non-autonomous vehicle, a semi-autonomous vehicle, or a fully autonomous vehicle, for example, as defined by National Highway Traffic Safety Administration (NHTSA). Examples of vehicles (such as the first vehicle 110A) of plurality of vehicles 110 may include, but are not limited to, a two-wheeler vehicle, a three-wheeler vehicle, a four-wheeler vehicle, or a hybrid vehicle. In some situations, the plurality of vehicles 110 may also include a vehicle with autonomous drive capability that uses one or more distinct renewable or non-renewable power sources, such as, a fossil fuel-based vehicle, an electric propulsion-based vehicle, a hydrogen fuel-based vehicle, a solar-powered vehicle, and/or a vehicle powered by other forms of alternative energy sources. Each vehicle (such as the first vehicle 110A) of the plurality of vehicles 110 may be a system through which an occupant may travel from a start point to a destination point.

In an embodiment, there may be vehicles other than the first vehicle 110A. For example, the plurality of vehicles 110 may include the first vehicle 110A and a Nth vehicle 110N. The Nth vehicle 110N shown in FIG. 1 is presented merely as an example. The plurality of vehicles 110 may include only one vehicle or more than three vehicles, without deviation from the scope of the disclosure. For the sake of brevity, only two vehicles have been shown in FIG. 1. However, in some embodiments, there may be more than three vehicles, without limiting the scope of the disclosure. It may be noted that the plurality of vehicles 110 are shown as cars in FIG. 1 is merely an example of a four-wheeled vehicle. Examples of the four-wheeled vehicle may include, but are not limited to, an electric car, an internal combustion engine (ICE)-based car, a fuel-cell based car, a solar powered-car, or a hybrid car. In some cases, the plurality of vehicles 110 may also be a two-wheeler vehicle. Examples of the two-wheeler vehicle may include, but are not limited to, an electric two-wheeler, an internal combustion engine (ICE)-based two-wheeler, or a hybrid two-wheeler. In yet other examples, the plurality of vehicles 110 may also include a three-wheeler vehicle, or a vehicle with more than four wheels, such as a lorry, truck, etc. In some situations, the plurality of vehicles 110 may be located at different geolocations of the plurality of geolocations 112.

The plurality of geolocations 112 may include various geographic locations of the buyer device 114, the seller device 116, or the plurality of vehicles 110. In an embodiment, each geolocation of the plurality of geolocations 112 may be determined based on a positioning of geographic coordinates of at least one of: a vehicle (such as the first vehicle 110A and the Nth vehicle 110N) of the plurality of vehicles 110, the buyer device 114, or the seller device 116. In some situations, the plurality of geolocations 112 may include a first geolocation 112A, a second geolocation 112B, and a Nth geolocation 112N. The Nth number of geolocations shown in FIG. 1 is presented merely as an example. The plurality of geolocations 112 may include only one geolocation or more than three geolocations, without deviation from the scope of the disclosure. For the sake of brevity, only three number of geolocations have been shown in FIG. 1. However, in some embodiments, there may be more than three geolocations, without limiting the scope of the disclosure.

In an embodiment, each vehicle (such as the first vehicle 110A, and the Nth vehicle 110N) of the plurality of vehicles 110 may be located at different geolocations of the plurality of geolocations 112. In an embodiment, the buyer 124 and the buyer device 114 may be located at the first geolocation 112A, and the first vehicle 110A owned by the seller 126 may be located at the second geolocation 112B, as shown in FIG. 1. In some situations, the buyer 124 associated with the buyer device 114 may be intending to purchase the first vehicle 110A to operate in the first geolocation 112A. In such situations, if the buyer 124 of the buyer device 114 is intending to purchase the first vehicle 110A for the first geolocation 112A of the buyer device 114, although the first vehicle 110A may comply the regulations to operate in the second geolocation 112B of the seller device 116, the buyer 124 may be required to check the requirements for the first vehicle 110A to operate in the first geolocation 112A. In some situations, the buyer 124 associated with the buyer device 114 may also intend to purchase the Nth vehicle 110N to operate in the Nth geolocation 112N The Nth geolocation shown in FIG. 1 is presented merely as an example. The plurality of geolocations 112 may include only one geolocation or more than three geolocations, without deviation from the scope of the disclosure. For the sake of brevity, only three number of geolocations have been shown in FIG. 1. However, in some embodiments, there may be more than three geolocations, without limiting the scope of the disclosure.

In another embodiment, if the seller 126 of the seller device 116 is intending to sell the first vehicle 110A from the second geolocation 112B of the seller device 116, although the first vehicle 110A may comply the regulations to operate in the second geolocation 112B of the seller device 116, the seller 126 may be required to check the requirements for the buyer 124 and/or for the first vehicle 110A, to operate in the first geolocation 112A. Each geolocation of the plurality of geolocations 112 may be determined using various visual and electronic methods that may include, but not limited to, position lines and position circles, celestial navigation, radio navigation, and a usage of satellite navigation systems (such as, a Global Positioning System (GPS), or a Global Navigation Satellite System (GNSS)) deployed in each of the electronic device 102, the buyer device 114, the seller device 116, or the plurality of vehicles 110.

The buyer device 114 may include suitable logic, circuitry, and interfaces that may be configured to communicate with the electronic device 102, via the communication network 120. In an embodiment, the buyer device 114 may transmit the first information 114A to the electronic device 102. The first information 114A may correspond to the first vehicle 110A to be purchased for the first geolocation 112A of the buyer device 114.

In some instances, if the buyer 124 is intending to purchase the first vehicle 110A from the second geolocation 112B of the seller device 116 to the first geolocation 112A of the buyer device 114, the buyer device 114 or the buyer 124 may be required to transmit the first information 114A (that may correspond to the first vehicle 110A) from the buyer device 114 to the electronic device 102. The electronic device 102 may receive the first information 114A and act as a server to facilitate transactions of purchasing the first vehicle 110A. The electronic device 102 may determine, based on the application of the neural network model 108, whether the set of features of the first vehicle 110A complies with the requirements of the first vehicle 110A, to operate the first vehicle 110A in the first geolocation of the buyer device 114. Based on the determination, the buyer device 114 may be configured to receive the buyer notification from the electronic device 102. Based on the buyer notification, the buyer 124 of the buyer device 114 may be notified in case of any requirements (such as the compliance requirements in purchasing the vehicle) for the first vehicle 110A. Such buyer notification may relate to an alert for the buyer 124 to avoid a loss in time that may incur in a communication between the buyer 124 of the buyer device 114 and other sellers, who does not meet the requirement of the buyer 124. Examples of the buyer device 114 may include, but are not limited to, a computing device, a smartphone, a cellular phone, a mobile phone, a gaming device, a mainframe machine, a server, a computer workstation, and/or a consumer electronic (CE) device.

The seller device 116 may include suitable logic, circuitry, and interfaces that may be configured to communicate with the electronic device 102, via the communication network 120. In an embodiment, the seller device 116 may transmit the second information 116A to the electronic device 102. In an embodiment, the second information 116A may be authenticated based on license information of the seller device 116, and registration information of the first vehicle 110A to be sold by the seller 126 of the seller device 116.

The second information 116A may correspond to the set of features of the first vehicle 110A to be sold by the seller 126 of the seller device 116 from the second geolocation 112B of the seller device 116. In an embodiment, the second geolocation 112B of the seller device 116 and the first vehicle 110A, may be different from the first geolocation 112A of the buyer device 114. For example, the first vehicle 110A may be located in the second geolocation 112B of the seller device 116 and may comply the requirements to operate in the second geolocation 112B of the seller device 116. In case the seller device 116 is intending to sell the first vehicle 110A from the second geolocation 112B of the seller device 116 to the buyer device 114 in geolocations (such as the first geolocation 112A) other than the second geolocation 112B of the plurality of geolocations 112, the seller device 116 or the seller 126 may be required to determine the requirements for at least one of: the buyer 124, the buyer device 114, or the first vehicle 110A to operate the first vehicle 110A in the first geolocation of the buyer device 114. Therefore, the seller device 116 may be configured to transmit the second information 116A of the first vehicle 110A to the electronic device 102 to determine the requirements of the first vehicle 110A to operate in the first geolocation 112A of the buyer device 114. The electronic device 102 may receive the second information 116A and act as a server to facilitate transactions of selling the first vehicle 110A. The electronic device 102 may determine, based on the application of the neural network model 108, whether the set of features of the first vehicle 110A (i.e., to be sold by the seller device 116) complies with the requirements to operate the first vehicle 110A in the first geolocation of the buyer device 114. Based on the determination of the electronic device 102, the seller device 116 may be configured to receive the seller notification from the electronic device 102. Based on the seller notification, the seller 126 of the seller device 116 may be notified in case of any requirements (such as the compliance requirements in selling the vehicle) for the first vehicle 110A. Such seller notification may relate to an alert for the seller 126 to avoid a loss in time that may incur in a communication between the seller 126 of the seller device 116 and other buyers, who does not meet the requirement of the seller 126. Examples of the seller device 116 may include, but are not limited to, a computing device, a smartphone, a cellular phone, a mobile phone, a gaming device, a mainframe machine, a server, a computer workstation, and/or a consumer electronic (CE) device.

The output device 118 may include suitable logic, circuitry, and interfaces that may be configured to render the generated notification from the electronic device 102. The output device 118 may be configured to output the notification and may be associated with (or integrated in) at least one of: the electronic device 102, the buyer device 114, or the seller device 116. In one example, the output device 118 may render the notification that may indicate information associated with the requirement (such as the structural feature requirement, or the functional feature requirement) of the first vehicle 110A to operate in the first geolocation 112A of the buyer device 114.

In another example, the output device 118 may render the notification that may correspond to information associated with a nearest regulatory authority (such as the regulatory authority 122) at the first geolocation 112A of the buyer device 114. The regulatory authority 122 may facilitate the buyer 124 to regulate or meet the requirements (such as the structural feature requirement, or the functional feature requirement) of the first vehicle 110A, to operate the first vehicle 110A in the first geolocation 112A of the buyer device 114. For example, if an emission test is required for the first geolocation 112A, the notification may indicate a phone number, an address, email address, or a website details of the nearest regulatory authority (such as the regulatory authority 122) at the first geolocation 112A which may support the buyer 124 or the seller 126 to conduct the emission test after or during the purchase of the first vehicle 110A for the first geolocation 112A.

In yet another example, the output device 118 may render the notification that may further correspond to information related to at least one of: a cost or a validity period, for the first vehicle 110A to meet the requirement for the first vehicle 110A, to operate in the first geolocation 112A of the buyer device 114, via the regulatory authority 122. For example, when the notification indicates that the information about the nearest regulatory authority 122 meets the requirement, the notification may further indicate the cost required by the regulatory authority 122 to meet the requirement (for example the cost required to conduct the emission test). In another example, the validity period may indicate time duration (in weeks/month/years) for the conducted test to be valid after being conducted by the regulatory authority 122. In an embodiment, the output device 118 may include one or more of: a display device, a speaker, or a vibratory motor.

In an embodiment, the output device 118 may be a display device that may include suitable logic, circuitry, and interfaces that may be configured to display the generated notification. The display device may be a touch screen which may enable a user (for example, the buyer 124 or the seller 126) to provide a user-input via the display device. The touch screen may be at least one of a resistive touch screen, a capacitive touch screen, or a thermal touch screen. In some embodiments, the display device may be integrated with at least one of: the electronic device 102, the buyer device 114, or the seller device 116, to output the generated notification. In some embodiments, the display device may be remotely coupled with at least one of: the electronic device 102, the buyer device 114, or the seller device 116, to output the generated notification. The display device may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device may refer to a display screen of a head mounted device (HMD), a smart-glass device, a see-through display, a projection-based display, an electro-chromic display, or a transparent display.

In another embodiment, the output device 118 may be a speaker that may include suitable logic, circuitry, and interfaces that may be configured to output the generated notification. For example, the generated notification may be in a form of a playback of an audio output. The speaker may be configured to receive electrical audio signals from the processor 106 and convert the received electrical audio signals into the audio/sound output. In some embodiments, the speaker may be integrated with at least one of: the electronic device 102, the buyer device 114, or the seller device 116, to output the generated notification. In some embodiments, the speaker may be remotely coupled with at least one of: the electronic device 102, the buyer device 114, or the seller device 116, to output the generated notification. Examples of the speakers may include, but are not limited to, a loudspeaker, a woofer, a sub-woofer, a tweeter, a wireless speaker, a monitor speaker, or other speakers or sound output device.

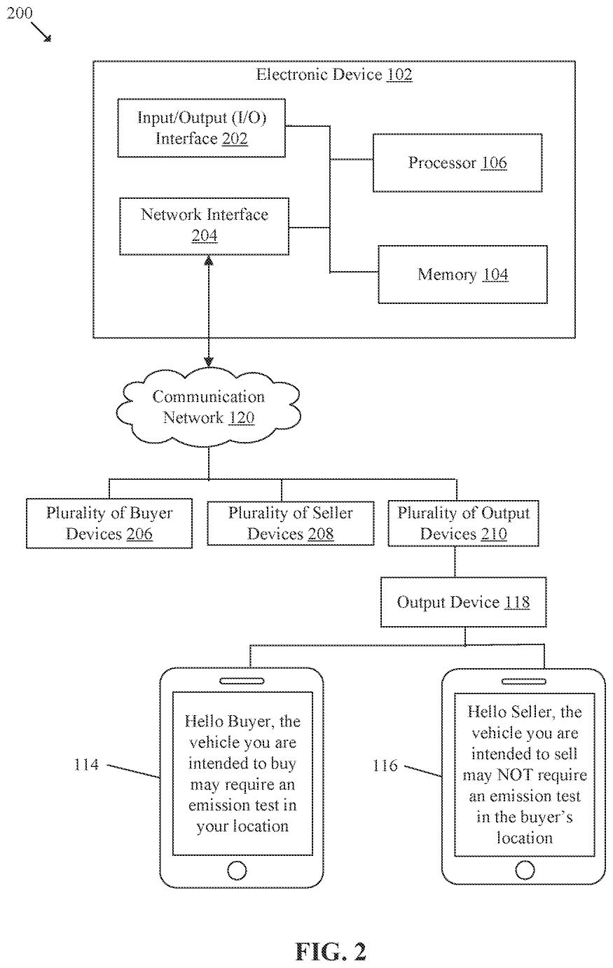

In yet another embodiment, the output device 118 may be the vibratory motor that may include suitable logic, circuitry, and interfaces that may be configured to output the generated notification. In an embodiment, the vibratory motor may be a DC motor that may be configured to output a tactile notification (as shown in FIG. 2) based on the generated notification. In some embodiments, the vibratory motor may be integrated with at least one of: the electronic device 102, the buyer device 114, or the seller device 116, to output the generated notification. In some embodiments, the vibratory motor may be remotely coupled with at least one of: the electronic device 102, the buyer device 114, or the seller device 116, to output the generated notification, via the communication network 120.

The communication network 120 may include a communication medium through which the electronic device 102, the buyer device 114, the seller device 116, and the output device 118 may communicate with each other. The communication network 120 may include one of: a wired connection or a wireless connection. Examples of the communication network 120 may include, but are not limited to, the Internet, a cloud network, a Cellular or Wireless Mobile Network (such as a Long-Term Evolution and 5G New Radio), a Wireless Fidelity (Wi-Fi) network, a Personal Area Network (PAN), a Local Area Network (LAN), or a Metropolitan Area Network (MAN). Various devices in the network environment 100 may be configured to connect to the communication network 120 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The regulatory authority 122 may include a public entity that controls licensing operations and working operations for each vehicle (such as the first vehicle 110A) of the plurality of vehicles 110. The regulatory authority 122 may be set up to improve safety and standards for each vehicle (such as the first vehicle 110A) of the plurality of vehicles 110. In certain situations, the regulatory authority 122 may be set up to improve a buyer protection from sellers who does not meet the requirements for the buyer 124 in his/her geolocation. For example, the buyer protection may correspond to the rendering of the buyer notification about the requirement of the vehicle available at the seller, so that, the buyer 124 may save a substantial amount of time that may be spent on sellers who does not meet the requirement of the buyer 124.

In other situations, the regulatory authority 122 may be set up to improve a seller protection from buyers who does not meet the requirements for the seller 126 in his/her geolocation. For example, the seller protection may correspond to the rendering of the seller notification about the requirement of the buyer 124 at the his/her geolocation (for example, the first geolocation 112A) of the buyer device (for example, the buyer device 114), so that, the seller 126 may select a prospective buyer and may save a substantial amount of time that may be spent on buyer who does not meet the available requirement of the seller 126 in the second geolocation 112B. Therefore, such seller notification may help the seller 126 to initiate communication only with selected buyers who are intending to buy the vehicle. For example, the seller 126 may interact with those buyers who comply with the requirements of operating the first vehicle 110A at the second geolocation 112B. Such requirements may be aligned with the available requirements of the seller 126 located in the second geolocation 112B to facilitate a minimal paperwork or other transaction related needs (for example, a transfer of license and regulation certificate from the seller to the buyer) for the seller 126 and/or the buyer 124.

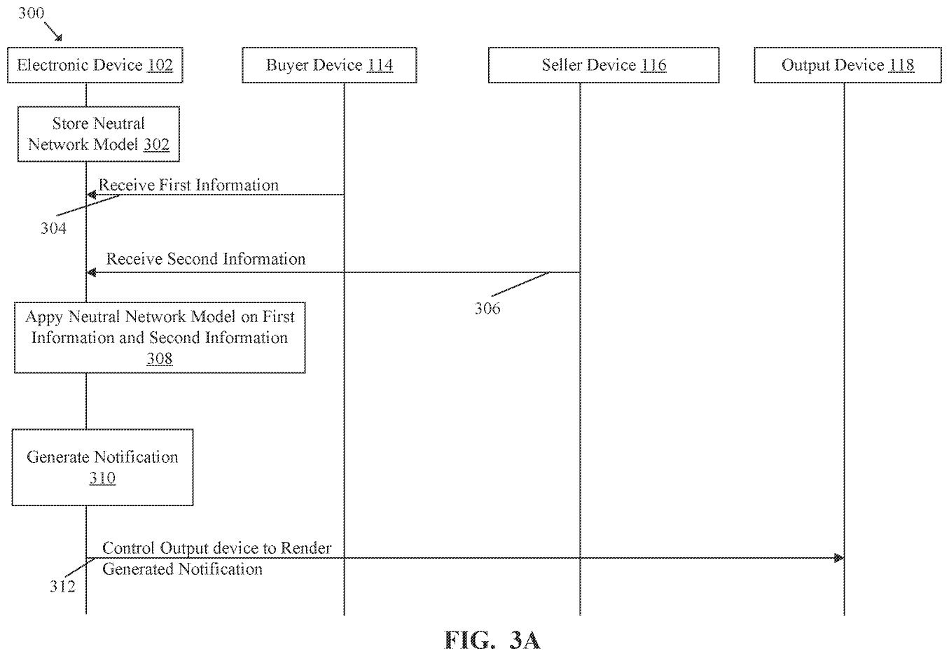

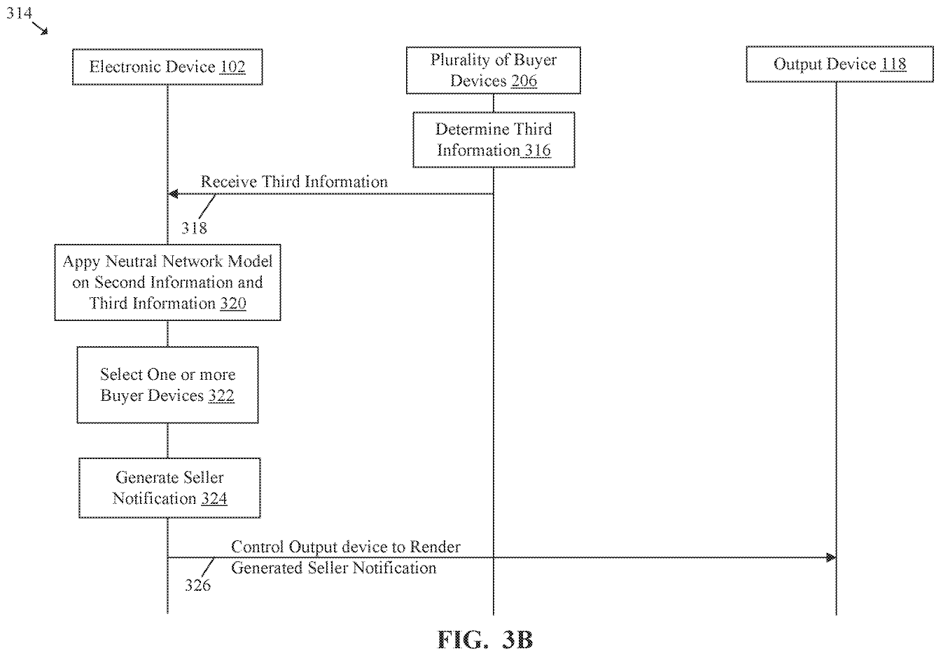

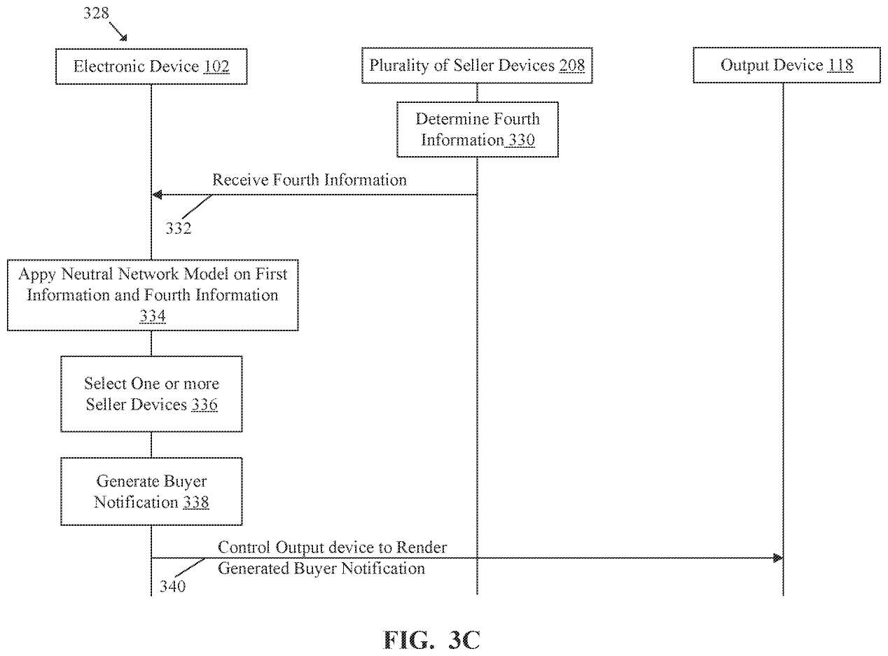

In operation with respect to FIG. 1, the electronic device 102 (such as a server) may facilitate vehicle related transactions between the buyer 124 and the seller 126 located at different geolocations (like different cities, states, provinces, countries, etc.). The electronic device 102 may store the neural network model 108 trained based on the regulation information 108A for the plurality of vehicles 110 at the plurality of geolocations 112. The regulation information 108A may correspond to the requirement of each of the plurality of features (such as the structural feature requirement or the functional feature requirement) of the plurality of vehicles 110 to operate in one or more geolocations of the plurality of geolocations 112. Therefore, if there is a need (that may be intended by the buyer device 114 or the seller device 116) to validate a requirement to operate the vehicle (such as the first vehicle 110A) in any geolocation (such as the first geolocation 112A) of the plurality of geolocations 112, the electronic device 102 may apply the stored neural network model 108 trained about the requirements of different features of various vehicles for different geolocations, to validate the requirement for the vehicle to operate the vehicle in corresponding geolocation of the plurality of geolocations 112. The details of the requirement of features for vehicles is described, for example, in FIG. 3.

Based on the storage, the electronic device 102 may receive the first information 114A from the buyer device 114 (for example, a mobile phone of the buyer 124). The first information 114A may correspond to the vehicle (such as the first vehicle 110A) to be purchased for the first geolocation 112A of the buyer device 114. In other instances, the first information 114A may also correspond to the features (such as the structural features, the functional features, etc.) of the first vehicle 110A. Based on reception of the first information 114A, the electronic device 102 may determine whether the first information 114A of the first vehicle 110A complies with the requirement stored in the electronic device 102, to operate the first vehicle 110A in the first geolocation 112A.

In an embodiment, the electronic device 102 may further receive the second information 116A from the seller device 116 (for example, a mobile phone of a seller 126) associated with the electronic device 102. The second information 116A may correspond to the set of features (such as the structural features, the functional features, etc.) of the vehicle (such as the first vehicle 110A) to be sold by the seller 126 of the seller device 116. The first vehicle 110A and the seller device 116 may be located at the second geolocation 112B of the seller device 116, which may be different from the first geolocation 112A of the buyer 124. In an embodiment, based on the reception of the second information 116A, the electronic device 102 may apply the trained neural network model 108 on the received first information 114A and the second information 116A to determine whether the set of features (such as the structural features, the functional features, etc.) of the first vehicle 110A complies with the requirement (such as the regulation information 108A) of the first vehicle 110A, to operate the first vehicle 110A in the first geolocation 112A of the buyer device 114 or not. In an example, the requirement for each of the set of features for the first vehicle 110A may be related to at least one of: the structural feature requirement(such as, a turbo attachment, a spoiler attachment, or a fuel-type of the vehicle, for the first vehicle 110A, which may be required for the first vehicle 110A to operate in the first geolocation of the buyer device 114), or the functional feature requirement (such as, changes in a functional configuration of the vehicle, for example, a licensing or purchase requirement, a speed limit requirement, etc.), which may be required for the first vehicle 110A to operate in the first geolocation 112A of the buyer device 114. The details related to the application of the trained neural network model are further provided on FIG. 3. Based on the determination, the electronic device 102 may generate the notification for the seller device 116 or the buyer device 114. The electronic device 102 may further control the output device 118 to render the generated notification.

In an alternate embodiment, the electronic device 102 may also assist the sellers to filter a potential buyer from multiple buyers, based on the requirement of a seller (such as the seller 126) to sell a vehicle (such as the first vehicle 110A). For example, the electronic device 102 may further receive third information from a plurality of buyer devices (as shown in FIG. 5). The third information may correspond to the first vehicle 110A to be purchased for the plurality of geolocations 112 of the plurality of buyer devices. Based on reception of the third information, the electronic device 102 may determine whether the received third information from the plurality of buyers complies with the regulation information 108A of the first vehicle 110A to be sold by the seller device 116. Based on the determination, the electronic device 102 may select one or more buyer devices (such as the buyer device 114) from the plurality of buyer devices and generate the seller notification based on the selection of the one or more buyer devices as described, for example, in FIG. 5. Based on the seller notification, the seller 126 may be notified of any requirement (such as the structural requirement or the functional requirement) in corresponding geolocation of each buyer of the plurality of buyers, and may further avoid a loss in time that may incur in the communication between the seller 126 and other buyers, who does not meet the requirement of the seller 126.

In an alternate embodiment, the electronic device 102 may also assist a buyer (such as the buyer 124) to filter a potential seller from multiple sellers, based on the requirement of the buyer 124 to purchase a vehicle (such as the first vehicle 110A). For example, the electronic device 102 may further receive fourth information from a plurality of seller devices (as shown in FIG. 4). The fourth information may correspond to the set of features of each of a set of vehicles to be sold by a plurality of sellers related to the plurality of seller devices. Based on reception of the fourth information, the electronic device 102 may select one or more seller devices (such as the seller device 116) from the plurality of seller devices and generate a buyer notification based on the selection of the one or more seller devices as described, for example, in FIG. 4. Based on the buyer notification, the buyer 124 may be notified of any requirement (such as the structural requirement or the functional requirement) in corresponding geolocation of each seller of the plurality of sellers, and may further avoid a loss in time that may incur in the communication between the buyer 124 and other sellers, who does not meet the requirement of the buyer 124.

FIG. 2 is a block diagram that illustrates an exemplary electronic device shown in the exemplary network environment of FIG. 1, in accordance with an embodiment of the disclosure. FIG. 2 is explained in conjunction with elements from FIG. 1. With reference to FIG. 2, there is shown a block diagram 200 of the electronic device 102. The electronic device 102 may include the memory 104, the processor 106, an Input/Output (I/O) interface 202, and a network interface 204. The processor 106 may be communicatively coupled to the memory 104, the I/O interface 202, and the network interface 204, through wired or wireless communication of the electronic device 102. In an embodiment, the network interface 204 of the electronic device 102 may be communicable coupled to at least one of: a plurality of buyer devices 206, a plurality of seller devices 208, or a plurality of output devices 210, via the communication network 120. The description of the memory 104 and the processor 106 are provided in FIG. 1, therefore not provided in FIG. 2 for the sake of brevity.

The I/O interface 202 may include suitable logic, circuitry, interfaces, and/or code that may be configured to receive an input and provide an output based on the received input from at least one of: the buyer device 114 or the seller device 116. The I/O interface 202 may include one or more input and output devices that may communicate with different components of the network environment 100. For example, the I/O interface 202 may receive user inputs, via a touchscreen of at least one of: the buyer device 114, the seller device 116, or the electronic device 102, to trigger execution of program instructions associated with different operations executed by the electronic device 102. In an embodiment, the I/O interface 202 may integrally include the output device 118. In another embodiment, the I/O interface 202 may be communicably coupled to the output device 118, via the communication network 120. Examples of the I/O interface 202 may include, but are not limited to, a touchscreen, a keyboard, a mouse, a joystick, a microphone, a display device, or a speaker.

The network interface 204 may include suitable logic, circuitry, and interfaces that may be configured to facilitate communication between the electronic device 102, the buyer device 114, the seller device 116, and the plurality of output devices 210 (including the output device 118), via the communication network 120. The network interface 204 may be implemented by use of various known technologies to support wired or wireless communication of the electronic device 102 with the communication network 120. The network interface 204 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 204 may be configured to communicate via wireless communication with networks, such as the Internet, an Intranet, or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5^{th} Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a near field communication protocol, a wireless pear-to-pear protocol, a protocol for email, instant messaging, and a Short Message Service (SMS).

The plurality of buyer devices 206 may include multiple buyer devices (such as the buyer device 114). Each buyer device of the plurality of buyer devices 206 may be configured to communicably couple with the electronic device 102, via the communication network 120. In an embodiment, each buyer device of the plurality of buyer devices 206 may be located in different geographic locations from the plurality of geolocations 112. The electronic device 102 may determine a compliance or requirement (based on the regulation information 108A) for each buyer to purchase a vehicle (such as the first vehicle 110A), based on the requirement for respective geographic location (such as the first geolocation 112A) of each buyer device of the plurality of buyer devices 206 in the plurality of geolocations 112. In another embodiment, all buyer devices of the plurality of buyer devices 206 may be located in same geographic location of the plurality of geolocations 112. In such situations, the electronic device 102 may determine the compliance or requirement for each buyer to purchase a vehicle based on the requirement of each buyer or the buyer device of the plurality of buyer devices 206.

The plurality of seller devices 208 may include multiple seller devices (such as the seller device 116). Each seller device of the plurality of seller devices 208 may be configured to communicably couple with the electronic device 102, via the communication network 120. In an embodiment, each seller device of the plurality of seller devices 208 may be located in different geographic locations from the plurality of geolocations 112. In such situations, the electronic device 102 may determine the compliance or requirement for each seller to sell the vehicle based on the requirement for respective geographic location of each seller or the seller device of the plurality of seller devices 208 and geographic locations of buyers in the plurality of geolocations 112. In another embodiment, all seller devices of the plurality of seller devices 208 may be located in same geographic location of the plurality of geolocations 112. In such situations, the electronic device 102 may determine the compliance for each seller to sell the vehicle based on the requirement of each seller or the seller device of the plurality of seller devices 208.

The plurality of output devices 210 include multiple output devices (such as the output device 118). Each output device of the plurality of output devices 210 may be configured to communicably couple with at least one of: the electronic device 102, the plurality of buyer devices 206, or the plurality of seller devices 208, via the communication network 120. In another embodiment, each output device of the plurality of output devices 210 may be integrally coupled with at least one of: the electronic device 102, the plurality of buyer devices 206, or the plurality of seller devices 208.

In an embodiment, each output device (such as the output device 118) of the plurality of output devices 210 may render the notification that is at least one of: a visual notification, an audible notification, an audio-visual notification, or a tactile notification. In some instances, the visual notification may be rendered via the display device of the output device 118. For example, if the output device 118 is associated with the buyer device 114, the output device 118 may render the notification as “Hello Buyer, the vehicle you are intending to buy may require an emission test in your location”, based on the determination of the compliance requirement for buyer's location, as shown in FIG. 2. In other example, if the output device 118 is associated with the seller device 116, the output device 118 may render the notification as “Hello Seller, the vehicle you are intending to sell may NOT require an emission test in the buyer's location”, based on the determination of the compliance requirement, as shown in FIG. 2. In yet another example, the output device 118 may render the notification as an audible notification that may be rendered via the speaker of the output device 118. In yet another example, the output device 118 may render the notification as an audio-visual notification 212C that may be rendered via the speaker and the display of the output device 118. In yet another example, the output device 118 may render the notification as a tactile notification that may be rendered via the vibratory motor of the output device 118, as described in FIG. 1.

FIGS. 3A-3C are diagrams that illustrate an exemplary execution pipeline to perform vehicle transaction, via an electronic device, in accordance with an embodiment of the disclosure. FIG. 3A is explained in conjunction with elements from FIG. 1 and FIG. 2. With reference to FIG. 3A, there is shown an exemplary execution pipeline 300. The execution pipeline 300 may include a set of operations (302 to 312) that may be executed by one or more components of FIG. 1, such as, the electronic device 102 or the processor 106. The set of operations may be performed by the electronic device 102 for generation of the notification that may indicate the compliance requirement or regulation during a purchase and/or a sale of the vehicle (such as the first vehicle 110A).

At 302, the neural network model 108 may be stored. In an embodiment, the processor 106 may control the memory 104 to store the neural network model 108. The electronic device 102 (such as a server related to vehicle purchase) may store the neural network model 108 which may be trained based on regulation information for the plurality of vehicles 110 at a plurality of geolocations 112. The regulation information may indicate various requirements (or compliance) of parts/functionalities (such as, the structural features or the functional features) of various vehicles to operate in different geolocations (for example different cities, states, provinces, or countries). For example, some geolocations may allow only electric vehicles to operate in that geolocations. In another example, some geolocations may require an emission test for a gas-fueled vehicle to operate in that geolocations. However, different geolocations (such as different country/state) may not require an emission test to be done to operate the gas-fueled vehicle in the corresponding country/state. Such requirement may be a compliance requirement for the vehicle to meet and to operate in a particular geolocation for a particular vehicle (like the gas-fueled vehicle or the electric vehicle). In such situations, the trained neural network model 108 may be aware (or trained) about various requirements (i.e., compliance requirements) for various structure/parts/functions (such as the structural features or the functional features) of different vehicles need to be met for the plurality of geolocations 112 globally. The neural network model may be trained based on millions of data records for various features, such as, but not limited to, a model of the vehicle, a type of manufacture of the vehicle, a year of manufacturing, a structural part of the vehicle, a functionality of the vehicle, a geolocation to operate the vehicle before/after purchase, or a requirement/compliance required for each feature of each vehicle for each geolocation. For example, the training of the neural network model 108 may facilitate intelligence for the electronic device 102 to determine on real-time basis, that a gas emission test (as the compliance requirement) may be required in a particular state of a country but may not be required for other states. In another example, the training of the neural network model 108 may facilitate intelligence for the electronic device 102 to determine that a bill of sale to be signed (as the compliance requirement) in order to sell and operate a vehicle for a particular state of a country but may not be required in other states of the country. In yet another example, a vehicle with a turbo engine (or a customized engine to enhance speed of the vehicle), or a specific body color (as structural feature) may not be allowed in a particular country. All such requirements (i.e., the compliance requirements) of vehicles (or of other products) for various geolocations may be referred as “special circumstances” to be considered during sell and purchase of vehicles.

At 304, the first information 114A may be received. In an embodiment, the processor 106 may receive the first information 114A from of the buyer device 114 of the buyer 124. In some instances, the buyer device 114 or the buyer 124 may be required to transmit the first information 114A (i.e., that may correspond to the first vehicle 110A which the buyer 124 is intending to purchase from the seller 126). In some embodiments, the first information 114A may correspond to the geolocation of the buyer 124 or the buyer device 114, like the first geolocation 112A where the first vehicle 110A has to be operated after purchase. The processor 106 of the electronic device 102 may receive the first information 114A and act as a server to facilitate transactions of purchasing the first vehicle 110A. In an embodiment, the first information 114A may indicate at least one of the structural feature requirement or the functional feature requirement for the first vehicle 110A to be purchased by the buyer 124. In certain instances, the structural feature requirement may indicate a structural configuration of the vehicle, for example, a ground clearance requirement (i.e., a distance between a road and an underbody of the vehicle), a tinted window requirement, an open roof-top requirement of the vehicle, a turbo attachment requirement, a spoiler attachment requirement, a fuel-type requirement of the vehicle such as the gas-fueled vehicle, the electric vehicle, the hybrid vehicle, a specific color vehicle, a vehicle with high-sound system or a vehicle with high capacity air-conditioning. In other instances, the functional feature requirement may indicate a functional configuration of the vehicle, for example, (but is not limited to), an engine control functions, a power control functions, a speed related functions, safety related functions or a function related to any specific part of the vehicle. In an embodiment, the first information 114A may further corresponds to a first feature (such as the structural feature or the functional feature) of the vehicle (such as the first vehicle 110A) to be purchased.

At 306, the second information 116A may be received. In an embodiment, the processor 106 may receive the second information 116A (indicating features associated with the first vehicle 110A, which the seller 126 is intending to sell to the buyer 124), via the seller device 116. In some instances, the seller device 116 or the seller 126 may be required to transmit the second information 116A that may correspond to the first vehicle 110A to the processor 106. The processor 106 may receive the second information 116A and act as a server to facilitate transactions of selling the first vehicle 110A. In an embodiment, the second information 116A may indicate limitations (such as limitations on certain geographic locations of sellers to sell the first vehicle 110A, or limitations on certain buyers based on their purchase history, etc.) as the requirement to sell the first vehicle 110A to the buyer 124.

In other embodiment, the second information 116A may indicate the structural features or the functional features of the first vehicle 110A. Therefore, the receipt of the second information 116A may facilitate the electronic device 102 (like a server) to get aware about the first vehicle 110A (and its parts or functionalities) that the seller 126 may need to sell using the seller device 116 and the electronic device 102. In certain instances, the structural feature may indicate a structural configuration of the vehicle, for example, a ground clearance (i.e., a distance between a road and an underbody of the vehicle), a color of the vehicle, a milage of the vehicle, a tinted window, an open roof-top of the vehicle, a turbo attachment, a spoiler attachment, or a fuel-type of the vehicle such as the gas-fueled vehicle, the electric vehicle, the hybrid vehicle, a vehicle with high sound system, or a vehicle with high capacity air conditioning. In other instances, the functional feature may indicate functional configuration of the vehicle, for example, (but is not limited to) an engine control functions, a power control functions, a speed related functions, safety related functions, or a function related to any specific part of the vehicle. In certain embodiments, the second information 116A may also indicate a set of certificates or licenses that the first vehicle 110A already have at the time of selling, for example (but not limited to) a licensing or purchase certification, a speed limit certificate, an emission test certification, a bill of sale certification, an insurance certificate, etc. In an embodiment, the second information 116A may indicate the second geolocation 112B in which the first vehicle 110A may be currently operated. The second geolocation 112B of the seller 126 may be different from the first geolocation 112A of the buyer 124.

In an embodiment, the processor 106 of the electronic device 102 may be configured to authenticate the second information 116A based on license information of the seller device 116 and the registration information (i.e., registration number) of the first vehicle 110A (to be sold) by the seller 126 of the seller device 116. The license information of the seller device 116 may indicate a login credential (like a user-name or email address) of the seller device 116 or the seller 126, to login to the electronic device 102 (i.e., a server used for vehicle transactions).

At 308, the trained neural network model 108 may be applied on the received first information 114A and the second information 116A. In an embodiment, the processor 106 may apply the trained neural network model 108 on the received first information 114A and the second information 116A to determine whether the set of features of the first vehicle 110A complies with the requirement (such as the structural feature requirement and/or the functional feature requirement) of the first vehicle 110A for the first geolocation 112A of the buyer device 114 or not. In another embodiment, the processor 106 may apply the trained neural network model 108 on the received first information 114A and the second information 116A to determine whether the corresponding feature (such as the structural feature and/or the functional feature) from the set of features of the vehicle (such as the first vehicle 110A) complies with the requirement (such as the structural feature requirement and/or the functional feature requirement) of the first feature of the first vehicle 110A for the first geolocation 112A of the buyer device 114 or not. In such a case, the information about the first feature may be received in the first information 114A from the buyer device 114. For example, the buyer device 114 may receive information about any specific part or function, from the buyer 124, for which the requirement check is be performed while purchasing the first vehicle 110A from the seller 126. In some instances, the neural network model 108 may compare the received first information 114A and the second information 116A with the stored regulation information 108A, to determine whether the set of features of the first vehicle 110A complies with the requirement of the first vehicle 110A to be operated in the first geolocation 112A. For example, if the buyer device 114 transmits the first information 114A that indicates that a gas-fueled vehicle has to be purchased for the first geolocation 112A of the buyer 124, the processor 106 may receive such structural feature requirement (like a gas fuel engine) as the first information 114A. In another example, if the seller device 116 transmits the second information 116A that indicates a gas-fueled vehicle availability at the second geolocation 112B of the seller 126, the processor 106 may receive structural features of the gas-fueled vehicle of the seller 126, as the second information. In an embodiment, the processor 106 may apply the trained neural network model 108 (including the regulation information 108A of multiple vehicles of multiple geo-locations) on the first information 114A (i.e., the gas-fueled vehicle requirement for the first geolocation 112A) and the second information 116A (i.e., features of the gas-fueled vehicle available at the seller 126). Based on the application of the neural network model 108 (that is trained on the compliance requirements for various vehicles for each geographic location of the plurality of geolocations 112), the processor 106 may determine a need or requirement to be fulfilled (for example an emission test is required by the first vehicle 110A), to operate the first vehicle 110A in the first geolocation 112A of the buyer 124 and/or the buyer device 114, where that specific need may not be required at the second geolocation 112B of the seller 126 to operate the first vehicle 110A.

In some embodiments, the first information 114A received from the buyer device 114 may indicate information about the first geolocation 112A where the buyer 124 may be located and the second information 116A received from the seller device 116 may indicate information about the set of features of the first vehicle 110A to be sold by the seller 126. Based on the application of the neural network model 108 (that is trained on the compliance requirements for various vehicles for each geographic location of the plurality of geolocations 112), the processor 106 may determine a need or requirement to be fulfilled (for example an emission test is required by the first vehicle 110A), to operate the first vehicle 110A in the first geolocation 112A of the buyer 124 and/or the buyer device 114. For example, all the features (except turbo engine fitted) of the first vehicle 110A fulfils the requirement of the first geolocation 112A of the buyer 124, however the fitted turbo engine in the first vehicle 110A may further require an appropriate test or certification as per the requirement for the first geolocation 112A of the buyer device 114.

At 310, the notification may be generated. In an embodiment, the processor 106 may generate the notification for at least one of: the buyer device 114 or the seller device 116, based on the application of the neural network model 108 (at 308). In some instances, based on the determination of the requirement or compliance (for example need for the emission test) for the first geolocation 112A of the buyer 124 and the buyer device 114, the processor 106 may generate the notification (such as an alert) for at least one of: the buyer 124 and/or the seller 126, via one of: the electronic device 102, the buyer device 114, or the seller device 116. The notification may indicate information associated with the compliance (or non-compliance) of the first vehicle 110A with the requirement (for example requirement of the emission test) of the first vehicle 110A for the first geolocation 112A of the buyer device 114. For example, the notification may indicate whether the first vehicle 110A (to be sold by the seller 126) complies or fulfills the requirements to operate the first vehicle 110A in the first geolocation 112A of the buyer 124 or not. Thus, the generated notification may indicate details for the vehicle to be sold and/or details related to the requirements to be met for the geolocations of the buyer 124, such the seller 126 (or the buyer 124) may appropriately decide to continue or discontinue the purchase related discussion with the buyer 124 (or the seller 126) and save appropriate effort and cost.

At 312, the generated notification may be rendered. In an embodiment, the processor 106 may be configured to control the output device 118 to render the generated notification. In some instances, the rendered notification may be displayed on the display device. For example, if the display device associated with the buyer device 114, the notification may be rendered as “Hello Buyer, the vehicle you are intending to buy may require an emission test in your location” OR “Hello Buyer, the vehicle you are intending to buy may NOT require an emission test in your location”, based on the determination of the compliance requirement, as shown in FIG. 2. In another example, if the display device associated with the seller device 116, the notification may be rendered as “Hello Seller, the vehicle you are intending to sell may require an emission test in the buyer's location”. OR “Hello Seller, the vehicle you are intending to sell may NOT require an emission test in the buyer's location” based on the determination of the compliance requirement, as shown in FIG. 2. Thus, rendered notification provided by the disclosed electronic device 102 may facilitate the buyer 124 or the seller 126 with appropriate details to continue or discontinue the communication between each other for vehicle transaction. In case, the compliance requirement is not met for the first vehicle 110A to operate in the first geolocation 112A of the buyer 124, the buyer 124 or the seller 126 may discontinue the transactional communication with each other and save respective time and cost (like to meet the compliance for the location of the buyer 124).

FIG. 3B is explained in conjunction with elements from FIG. 1, FIG. 2, and FIG. 3A. With reference to FIG. 3B, there is shown an exemplary execution pipeline 314. The execution pipeline 314 may include a set of operations (316 to 326) that may be a continuation of the execution pipeline 300 to be executed by one or more components of FIG. 1, such as, the electronic device 102 or the processor 106. The set of operations may be performed by the electronic device 102 for generation of the notification that may indicate the compliance requirement or regulation during a sale of the vehicle (such as the first vehicle 110A).

At 316, third information may be determined. In an embodiment, the plurality of buyer devices 206 may determine the third information. The third information may correspond to the vehicle (such as the first vehicle 110A) to be purchased, from the seller 126 for the plurality of geolocations 112 of the plurality of buyer devices 206. To ease the communication between each buyer of a plurality of buyers of the plurality of buyer devices 206 and the seller 126, the plurality of buyer devices 206 may determine the third information and transmit to the electronic device 102. In an embodiment, the third information received from each of the buyer device may be similar to the first information as described, for example, 304. Therefore, the third information may relate to information about the first vehicle 110A that each buyer needs to purchase and/or relate to the geolocation of the plurality of buyer devices 206 where the first vehicle 110A has to be operated after the purchase from the seller 126.

At 318, the third information may be received. In an embodiment, the processor 106 may receive the third information from the plurality of buyer devices 206. If multiple requirements received for the purchase of the first vehicle 110A from the seller 126, there may be a loss in time for the seller 126 to validate each buyer of the plurality of buyers and determine the potential buyer from the plurality of buyers of the plurality of buyer devices 206. To avoid such loss in time, the electronic device 102 may act as a server to facilitate transactions of purchasing/selling the first vehicle 110A between the plurality of buyer devices 206 and the seller 126. The processor 106 of the electronic device 102 may receive the third information from the plurality of buyer devices 206, to validate the potential buyer (such as the buyer 124) from the plurality of buyers of the plurality of buyer devices 206.

At 320, the neural network model 108 may be applied on the received second information 116A and the third information. In an embodiment, the processor 106 may apply the neural network model 108 on the received second information 116A and the third information, to determine whether the set of features of the first vehicle 110A complies with the requirement (such as the structure feature requirement or the functional feature requirement) of the first vehicle 110A for each of the plurality of geolocations 112 of the plurality of buyer devices 206. In some instances, the neural network model 108 may compare the received second information 116A and the third information with the regulation information 108A, to determine whether the set of features of the first vehicle 110A complies with the requirement of the first vehicle 110A to be operated in the plurality of geolocations 112 of the plurality of buyer devices 206. For example, if the plurality of buyer devices 206 transmits the third information that indicates a gas-fueled vehicle has to be purchased (or its requirement) for the first geolocation 112A of the plurality of buyers, the processor 106 may receive such structural feature requirement (like a gas fuel engine) as the third information. The processor 106 may apply the trained neural network model 108 (including the regulation information 108A of multiple vehicles of multiple geo-locations) on the third information (i.e., the gas-fueled vehicle requirement for geo-locations of the plurality of buyer devices 206) and the second information 116A (i.e., features of the gas-fueled vehicle available of the seller 126), with the regulation information 108A. Based on the application of the neural network model 108 (that is trained on the compliance requirements for various vehicles each geographic location of the plurality of geolocations 112), the processor 106 may determine a need or requirement to be fulfilled (for example an emission test in required by the first vehicle 110A), to operate the first vehicle 110A in one or more geolocations of the plurality of geolocations 112 of the plurality of buyer devices 206. In an example, based on the application of the neural network model 108 that is trained on the compliance requirements for each geographic location of the plurality of geolocations, the processor 106 may determine a potential buyer (such as the buyer 124) from the plurality of buyers, who does not need the emission test to operate the first vehicle 110A corresponding geolocation of the potential buyer, as described, for example, at 322. For the seller 126, the buyer 124 (for whom the emission test is not required) may be the potential buyer, because the seller 126 may save certain time/cost to pursue the emission test certificate from an authority (like regulatory authority 122) and because other buyers of the plurality of buyers may negotiate with the seller 126 in the pricing for vehicle transaction due to required emission test for respective geolocations.

At 322, one or more buyer devices may be selected. In an embodiment, the processor 106 may select one or more buyer devices (such as the buyer device 114) from the plurality of buyer devices 206, based on the application of the neural network model 108. For example, the processor 106 may determine a potential buyer device (such as the buyer device 114) from the plurality of buyer devices 206 or potential buyer, who does not need the emission test for the first vehicle 110A in corresponding geolocation of the potential buyer device, to further operate the first vehicle 110A in corresponding geolocation of the potential buyer device. As the disclosed electronic device 102 selects only those buyer devices or buyers that have geographic locations, which do not need the emission test requirement, there may be a significant reduction in the loss in time of the seller 126, and the seller 126 may interact only with one or more potential buyer devices or buyers. In an example, the disclosed electronic device 102 (using the trained neural network model 108) may select only those buyer devices or buyers that have geographic locations for which the requirements are met by the first vehicle 110A of the seller 126. For example, in case the first vehicle 110 has a turbo engine fitted for generation of more power or speed, and a particular geolocation of a specific buyer fulfils such requirement, then such buyer may be selected by the disclosed electronic device 102 as potential buyer.

At 324, a seller notification may be generated. In an embodiment, the processor 106 may generate the seller notification based on the selection of the one or more buyer devices from the plurality of buyer devices 206. In an embodiment, the processor 106 may generate the notification for the seller device 116 or the seller 126. In some instances, based on the determination of the requirement or compliance (for example need for the emission test) in one or more geolocations of the plurality of geolocations 112 of the plurality of buyer devices 206, the processor 106 may generate the notification (such as an alert) for the seller 126, via one of: the electronic device 102 or the seller device 116. The notification may indicate information associated with the compliance (or non-compliance) of the first vehicle 110A with the requirement (for example emission test requirement) for each buyer device (such as the buyer device 114) of the plurality of buyer devices 206 at corresponding geolocation (such as the first geolocation 112A) of the plurality of geolocations 112.

At 326, the generated seller notification may be rendered. In an embodiment, the processor 106 may be configured to control the output device 118 to render the generated seller notification. In some instances, the rendered seller notification may be displayed in the display device. For example, if the display device is associated with the seller device 116 of the seller 126, the notification may be rendered as “Hello Seller, the vehicle you are intending to sell may require an emission test in the buyer's location”. OR “Hello Seller, the vehicle you are intending to sell may NOT require an emission test in the buyer's location” based on the determination of the compliance requirement, as shown in FIG. 2. In an example, the seller notification may indicate a potential list of buyers (or buyer devices) for which the set of features of the first vehicle 110A (to be sold) comply or fulfil the respective requirements of the geolocations of the potential buyers. Thus, the disclosed electronic device 102 may facilitate the seller 126 with appropriate details about the buyers (their geolocations or the requirements) to further continue the communication with only the potential buyers and save time with respect to non-potential buyers.

FIG. 3C is explained in conjunction with elements from FIG. 1, FIG. 2, and FIGS. 3A-3B. With reference to FIG. 3C, there is shown an exemplary execution pipeline 328. The execution pipeline 328 may include a set of operations (330 to 340) that may be an alternate continuation of the execution pipelines 300 and 314 to be executed by one or more components of FIG. 1, such as, the electronic device 102 or the processor 106. The set of operations may be performed by the electronic device 102 for generation of the notification that may indicate the compliance requirement or regulation during a sale of the vehicle (such as the first vehicle 110A).

At 330, fourth information may be determined. In an embodiment, the plurality of seller devices 208 may determine the fourth information. The fourth information may correspond to a sale of the vehicle (such as the first vehicle 110A) from the plurality of seller devices 208 for the buyer 124 associated with the buyer device 114. To ease the communication between each seller of a plurality of sellers of the plurality of seller devices 208 and the buyer 124, the plurality of seller devices 208 may determine the fourth information and transmit to the electronic device 102. In an embodiment, the fourth information received from each of the plurality of seller devices 208 may be similar to the second information 116A as described, for example, at 306. Therefore, the fourth information may correspond to the set of features of each of the set of vehicles to be sold by the plurality of sellers related to the plurality of seller devices 208. The fourth may indicate the structural features or the functional features of the set of vehicles to be sold by the plurality of sellers. Therefore, the receipt of the fourth information may facilitate the electronic device 102 (like a server) to get aware about the set of vehicles (and their parts or functionalities) that the plurality of sellers may intent to sell to the buyer 124, using the plurality of seller devices 208 and the electronic device 102.

In an embodiment, the fourth information may further indicate a level of damage in the set of vehicles to be sold by the plurality of sellers related to the plurality of seller devices 208. The level of damage may be determined based on at least one of: registration information of the set of vehicles, or a visual inspection information of the set of vehicles stored in the electronic device 102 for each of the set of vehicles. In an example, the registration information of the set of vehicles may be retrieved from the memory 104. In an embodiment, the neural network model 108 may also be trained based on information about level of damages of the vehicles. The registration information may indicate a service life or accidental history of each vehicle of the set of vehicles. In an embodiment, the visual inspection information may be retrieved from an imaging device associated with each vehicle of the set of vehicles or received from the plurality of seller devices 208 for the set of vehicles. Based on the visual inspection information, each seller device of the plurality of seller devices 208 or the electronic device 102 may determine a crack, a dent, or other mechanical defects in the structural features of each vehicle of the set of vehicles to be sold by each seller of the plurality of sellers. Based on the determination, each seller device of the plurality of seller devices 208 may transmit the determined fourth information to the electronic device 102.

In an embodiment, the fourth information may further indicate a service history of the set of vehicles to be sold by the plurality of sellers related to the plurality of seller devices 208. For example, the service history may be determined based on at least one of: a number of repairs of the vehicle from a particular service center, or a number of accidents of the set of vehicles to be sold. The processor 106 may be configured to retrieve the information (from the memory 104 or from the regulatory authority 122) about the service history of each of the set of vehicles, based on the registration information received from the plurality of seller device 116 about the set of vehicles.

In another embodiment, the fourth information may correspond to a need for sale for the set of vehicles to be sold by the plurality of sellers related to the plurality of seller devices 208, or correspond to a fit for sale certificate received from the regulatory authority 122 for the set of vehicles of the plurality of vehicles 110. The need for sale may correspond to a purpose of sale (or intent to sale) for the vehicle (such as the first vehicle 110A) from the seller. The information about the fit for sale certificate may correspond to a clearance provided by the regulatory authority 122 to sell the vehicle to a buyer (such as the buyer 124). Based on the fit for sale certificate, the set of vehicles (such as the first vehicle 110A) may be listed in a user interface (UI) of the electronic device 102 for sale for the buyer 124 of the buyer device 114.

At 332, the fourth information may be received. In an embodiment, the processor 106 may receive the fourth information from each seller device of the plurality of seller devices 208. For example, if multiple proposals received for the sale of the vehicle from the plurality of sellers of the plurality of seller devices 208, there may be a loss in time for the buyer 124 to individually validate each seller of the plurality of seller devices (or respective vehicle) and determine the potential vehicle (such as the vehicle that has higher number of features meeting the regulations of the geolocation of the buyer 124, or a minimum level of damage or the vehicle with an increased service life) from the set of vehicles of the plurality of sellers. To avoid such loss in time for the buyer 124, the electronic device 102 may act as a server to facilitate transactions of purchasing/selling the set of vehicles (including the first vehicle 110A) between the plurality of seller devices 208 and the buyer 124. The processor 106 of the electronic device 102 may receive the fourth information from the plurality of seller devices 208, to identify and/or validate the potential vehicle (such as the first vehicle 110A) and the potential seller (such as the seller 126) from the plurality of sellers associated with the plurality of seller devices 208.

At 334, the neural network model 108 may be applied on the received first information 114A and the fourth information. In an embodiment, the processor 106 may apply the neural network model 108 on the received first information 114A and the fourth information, to determine whether each of the set of features of the set of vehicles (to be sold by the plurality of sellers) complies (or not) with the requirement (such as the structure feature requirement or the functional feature requirement) for the first geolocation 112A of the buyer 124 (associated with the buyer device 114). In some instances, the neural network model 108 may compare the received first information 11$A and the fourth information with the regulation information 108A, to determine whether each of the set of features of the set of vehicles complies (or not) with the requirement of the first vehicle 110A for the first geolocation 112A of the buyer 124. Details of the application of the neural network model 108 is further described, for example, at 308 of FIG. 3A.

In another embodiment, the processor 106 may apply the neural network model 108 on the received first information 114A and the fourth information, to determine whether or not the level of damage related to the set of features of the set of vehicles complies with the requirement (such as the structural feature requirement and/or the functional feature requirement) of each vehicle of the set of vehicles for the first geolocation 112A of the buyer 124. In some instances, the neural network model 108 may compare the received first information 114A and the fourth information with the regulation information 108A, to determine whether or not the level of damage (related to the set of features of the set of vehicles) complies with the compliance requirement (i.e., retrieved based on the regulation information 108A) of each vehicle of the set of vehicles to operate in the first geolocation 112A of the buyer 124. For example, if a first seller device of the plurality of seller devices 208 transmits the fourth information that indicates a ten-years old vehicle, the processor 106 may determine based on the regulation information 108A, that the ten-year old vehicle may not fulfil (or compliant) with the requirement of the first geolocation of the buyer 124. In another example, if the first information 114A received from the buyer device 114 indicates that the buyer 124 needs a 5-years old vehicle and the stored regulation information indicates that the vehicle allowed to operate in the first geolocation 112A of the buyer 124 should not be more than 7 years old, then the processor 106 (using the neural network model 108) may determine that the ten-years old vehicle of the first seller may not be compliant with the requirement of the buyer 124 for the first geolocation 112A. In another example, if the fourth information received from a seller device indicates a particular damage on the body of the vehicle (to be sold) and that damage does not fulfil the requirement of the first geolocation 112A, then the processor 106 (using the regulation information 108A) may determine that the particular damage on the body (as a feature) of the vehicle may not comply with the requirement of the first geolocation 112A of the buyer 124. Thus, based on the application of the neural network model 108 that is trained on the compliance requirements for each geographic location of the plurality of geolocations, the processor 106 may determine that the vehicle associated with the first seller does not comply with the requirement of the vehicle for the first geolocation 112A of the buyer device 114 and may reject the first seller.

In another example, if a second seller device of the plurality of seller devices 208 transmits the fourth information that indicates a service history of the vehicle (to be sold), like a complete engine has been changed due to an accident with the vehicle in past or a service related to a particular faulty part of the vehicle is frequently performed in past. In such instances, the processor 106 may apply the trained neural network model 108 on the fourth information (i.e., indicating service history of the vehicle to be sold) and the first information 114A (i.e., indicating the first geolocation 112A of the buyer device 114) to determine that the vehicle associated with the second seller may comply (or not) with the requirement of the buyer 124 or of the first geolocation 112A and/or may further indicate an appropriate test to be performed (like requires an emission test) to operate the vehicle in the first geolocation of the buyer device 114. The processor 106 may accordingly select or reject the second seller associated with the plurality of seller devices 208, as described at 336.

In another example, the second seller device of the plurality of seller devices 208 transmits the fourth information that indicates the vehicle (to be sold) does not have a fit sale certificate, and the stored regulation information 108A indicates that such certificate may be required to meet the requirement of the first geolocation 112A (i.e., indicated by the first information 114A). The processor 106 may apply the trained neural network model 108 on the fourth information and the first information 114A to determine that the vehicle associated with the second seller may comply (or not) with the requirement of the buyer 124 or of the first geolocation 112A and may further select or reject the second seller, as described at 336.

In another example, the fourth information indicates that a seller does not have intent to sale (i.e., need for sale described at 330) and the stored regulation information 108A indicates that the intent to sale may be required to meet the requirement of the first geolocation 112A (i.e., indicated by the first information 114A). The processor 106 may apply the trained neural network model 108 on the fourth information and the first information 114A to determine that the vehicle associated with the second seller may comply (or not) with the requirement of the buyer 124 or of the first geolocation 112A and may further select or reject the second seller, as described at 336. In the instant example, the seller which does not indicate the need for sale (via the fourth information) may not comply with the requirement of the first geolocation 112A and may be rejected by the disclosed electronic device 102 for the buyer 124.

At 336, one or more seller devices may be selected. In an embodiment, the processor 106 may select one or more seller devices (such as the seller device 116) from the plurality of seller devices 208 (or may select one or more sellers from the plurality of sellers), based on the application of the neural network model 108 (as described, for example in 334). For example, the processor 106 may determine a potential seller device (such as the seller device 116) from the plurality of seller devices 208 or the potential seller who's vehicle may comply with the requirement of the first geolocation 112A or has the vehicle with the minimum level of damage, or the vehicle with the increased service life or the vehicle with better service history, or provided the intent to sale or fit to sale certificate, as described in 334. As the processor 106 selects only potential seller devices from the plurality of seller devices 208, there may a significant reduction in the loss in time of the buyer 124, and the buyer 124 may interact only with one or more potential seller devices or potential sellers.

At 338, buyer notification may be generated. In an embodiment, the processor 106 may generate the buyer notification based on the selection of one or more seller devices from the plurality of seller devices 208. In an embodiment, the processor 106 may generate the notification for the buyer 124 or the buyer device 114. In some instances, based on the determination on that the vehicle complies with the requirement of the first geolocation 112A or the vehicle has the minimum level of damage or the vehicle with the increased service life, or the vehicle with better service history, or seller has provided the intent to sale or fit to sale certificate (as described in 334), the processor 106 may generate the notification (such as an alert) for the buyer 124, via one of: the electronic device 102 or the buyer device 114. The buyer notification may indicate information associated with the compliance requirement of the level of damage, service life/history, fit for sale, intent to sale, and/or required tests for the vehicle to be operated in the first geolocation 112A of the buyer device 114. In some embodiments, the buyer notification may indicate a list of potential sellers (i.e., whose vehicles comply with the requirement of the buyer 124 or with the requirement of the first geolocation 112A for which the vehicle has to be purchased) for the buyer 124 for further facilitate the communication related to vehicle transaction between a particular seller and the buyer 124.

At 340, the generated buyer notification may be rendered. In an embodiment, the processor 106 may be configured to control the output device 118 to render the generated buyer notification. In some instances, the rendered buyer notification may be displayed in the display device. For example, if the display device is associated with the buyer device 114, the notification may be rendered as “Hello Buyer, the vehicle you are intending to buy may require an emission test in your location” OR “Hello Buyer, the vehicle you are intending to buy may NOT require an emission test in your location”, based on the determination of the compliance requirement, as shown in FIG. 2. In another example, if the display device is associated with the buyer device 114, the notification may be rendered as “Hello Buyer, the vehicle you are intending to buy may have the minimum level of damage; but may require an emission test in your location” OR “Hello Buyer, the vehicle you are intending to buy has the maximum level of damage”, In another example, the buyer notification may be rendered as “Hello buyer, these are the potential sellers with vehicles which may fulfil all the compliance requirements for your country”.

It may be noted that the execute pipeline 300, the execute pipeline 314 and the execute pipeline 328 explained with respect to FIGS. 3A, 3B, and 3C, respectively may be operated as separate operation or may be operated as combined operations in different vehicle transaction situations. In certain embodiments, execution pipelines of FIGs, 3A-3C may be further divided into additional operations, combined into fewer operations, or eliminated, depending on a particular implementation without detracting from the essence of the disclosed embodiments.

FIG. 4 is a diagram that illustrates an exemplary execution pipeline to perform vehicle transaction, via a buyer device, in accordance with an embodiment of the disclosure. FIG. 4 is explained in conjunction with elements from FIG. 1, FIG. 2, and FIGS. 3A-3C. With reference to FIG. 4, there is shown an exemplary execution pipeline 400. The execution pipeline may include a set of operations (402 to 416) that may be executed by one or more components of FIG. 1, such as, the buyer device 114. The set of operations may be performed by the buyer device 114 for generation of the notification associated with the compliance requirement during purchase of the vehicle (such as the first vehicle 110A).

At 402, the neural network model 108 may be stored. In an embodiment, the buyer device 114 may include a memory (such as the memory 104) to store the neural network model 108, which may be trained based on the regulation information 108A for the plurality of vehicles 110 at a plurality of geolocations 112. The regulation information 108A may correspond to the requirement of each of the plurality of features of the plurality of vehicles 110 to operate in one or more geolocations of the plurality of geolocations 112. Details about the neural network model 108 are described further, for example, at 302 of FIG. 3A.

At 404, the first information may be acquired. In an embodiment, the buyer device 114 may acquire the first information 114A from the memory of the buyer device 114. In some embodiments, the first information 114A may be acquired as user input from the buyer 124. Details of the first information 114A is further described, for example, at 304 of FIG. 3A.

At 406, the second information 116A from the plurality of seller devices 208 may be received. In an embodiment, the buyer device 114 may receive the second information 116A from each of the plurality of seller devices 208. In an embodiment, the second information 116A may correspond to the set of features (such as at least one of: the structural features or the functional features) of each of the set of vehicles (such as the first vehicle 110A) to be sold by each seller of the plurality of sellers related to the plurality of seller devices 208. It may be noted that the geolocations of the plurality of seller devices 208 and the set of vehicles are different from the first geolocation 112A of the buyer device 114. Details of the second information 116A are further described, for example, at 306 of FIG. 3A.

At 408, the neural network model 108 may be applied on the received first information 114A and the second information 116A. In an embodiment, the buyer device 114 may apply the neural network model 108 on the received first information 114A and the second information 116A to determine whether the set of features (such as the structural features and/or the functional features) of the set of vehicles complies with the requirement for the first vehicle 110A for the first geolocation 112A of the buyer device 114. In an embodiment, the requirement for each of the set of features for the first vehicle 110A may be related to at least one of: the structural feature requirement of the first vehicle 110A or the functional feature requirement of the first vehicle 110A, which may be required for the first vehicle 110A to operate in the first geolocation 112A of the buyer device 114. Details of the application of the neural network model 108 are further described, for example, at 308 of FIG. 3A.

At 410, one or more seller devices from the plurality of seller devices 208 may be selected. In an embodiment, the buyer device 114 may select one or more seller devices from the plurality of seller devices 208 based on the application of the neural network model 108. For example, the buyer device 114 may determine a suitable seller device or seller that has a vehicle (such as the first vehicle 110A), which complies with the compliance requirement for the first geolocation 112A of the buyer device 114. Details of the selection of the seller device (such as the seller device 116) are further described, for example, at 336 of FIG. 3C.

At 412, the buyer notification may be generated. In an embodiment, the buyer device 114 may generate the buyer notification based on the selection of the one or more seller devices. In an example, the buyer device 114 may generate the notification for each selected seller (such as the seller 126) of the plurality of sellers associated with the plurality of seller devices 208. Details of the generation of the buyer notification are further described, for example, at 338 of FIG. 3C. In some embodiments, the buyer device 114 may generate the buyer notification directly based on the application of the neural network model 108 (without the selection of one or more seller devices). In such case, the buyer notification may indicate a list of the plurality of seller devices 208 (or information about the plurality of sellers) and information indicating whether the corresponding vehicle of each of the plurality of seller does comply or does not comply with the requirement of the first geolocation of the buyer device 114. In certain embodiments, the buyer notification may indicate the requirement for at least one the set of features of the set of vehicles (to be sold by the plurality of sellers) for the first geolocation 112A. For example, the buyer notification may indicate that a emission test requirement has to be fulfilled for vehicle of a first seller and a bill of sale requirement has to be fulfilled for vehicle of a second seller for the first geolocation 112A of the buyer 124.

At 414, the buyer notification may be rendered on the output device 118. In an embodiment, buyer device 114 may control the output device 118 to render the generated buyer notification. In some instances, the rendered buyer notification may be displayed in the display device. For example, in the display device associated with the buyer device 114, the notification may be rendered as “Hello Buyer, the vehicle you are intending to buy may require an emission test in your location” OR “Hello Buyer, the vehicle you are intending to buy may NOT require an emission test in your location”, based on the determination of the compliance requirement, as shown in FIG. 2. Details of rendering of the buyer notification are further described, for example, at 340 of FIG. 3C.

The process pipeline shown in FIG. 4 is illustrated as discrete operations from 402-416, which may relate to execution of the vehicle transaction, via the buyer device 114, and corresponding generation of the notification associated with the compliance requirement during the purchase of the vehicle (such as the first vehicle 110A), via the buyer device 114. However, in certain embodiments, such discrete operations may be further divided into additional operations, combined into fewer operations, or eliminated, depending on a particular implementation without detracting from the essence of the disclosed embodiments.

FIG. 5 is a diagram that illustrates an exemplary execution pipeline to perform vehicle transaction, via a seller device, in accordance with an embodiment of the disclosure. FIG. 5 is explained in conjunction with elements from FIG. 1, FIG. 2, FIGS. 3A-3C, and FIG. 4. With reference to FIG. 5, there is shown an exemplary execution pipeline 500. The execution pipeline may include a set of operations (502 to 516) that may be executed by one or more components of FIG. 1, such as, the seller device 116. The set of operations may be performed by the seller device 116 for generation of the notification associated with the compliance during selling of the vehicle (such as the first vehicle 110A).

At 502, the neural network model 108 may be stored. In an embodiment, the seller device 116 may include a memory (such as the memory 104) to store the neural network model 108, which may be trained based on the regulation information 108A for the plurality of vehicles 110 at a plurality of geolocations 112. The regulation information 108A may correspond to the requirement of each of the plurality of features of the plurality of vehicles 110 to operate in one or more geolocations of the plurality of geolocations 112. Details about the neural network model 108 are described further, for example, at 302 of FIG. 3A.

At 504, the first information 114A may be received. In an embodiment, the seller device 116 may receive the first information 114A from each buyer device (such as the buyer device 114) of the plurality of buyer devices 206. In an embodiment, the first information 114A may correspond to the first vehicle 110A to be purchased for the plurality of geolocations 112 of the plurality of buyer devices 206. The first information 114A may further correspond to the plurality of geolocations 112 of the plurality of buyer devices 206 for which the first vehicle 110A has to be purchased from the seller 126. To ease the communication between each buyer of the plurality of buyer devices 206 and the seller device 116, the plurality of buyer devices 206 may determine the first information 114A and transmit to the seller device 116. The seller device 116 may receive the first information 114A from each buyer device of the plurality of buyer devices 206. Details of the first information 114A is further described, for example, at 304 of FIG. 3A and at 316 and 318 of FIG. 3B.

At 506, the second information 116A may be acquired. In an embodiment, the seller device 116 may acquire the second information 116A from the memory of the seller device 116. In some embodiments, the second information 116A may be acquired as user inputs from the seller 126. In an embodiment, the second information may correspond to the set of features (such as the structural feature and/or the functional feature) of the first vehicle 110A to be sold by the seller 126 of the seller device 116 from the second geolocation 112B, which may be different from the other geolocations of the plurality of geolocations 112 of the plurality of buyer devices 206. Details of the second information 116A are further described, for example, at 306 of FIG. 3A.

At 508, the neural network model 108 may be applied on the received first information 114A and the second information 116A. In an embodiment, the seller device 116 may apply the neural network model 108 on the received first information 114A and the second information 116A to determine whether the set of features of the first vehicle 110A complies with the requirement for the first vehicle 110A for each of the plurality of geolocations 112 of the plurality of buyer devices 206. In an embodiment, the requirement for each of the set of features for the first vehicle 110A may be related to at least one of:

the structural feature requirement of the first vehicle 110A or the functional feature requirement of the first vehicle 110A, which may be required for the first vehicle 110A to operate in at least one geolocation of at least one of the plurality of buyer devices 206.

Details of the application of the neural network model 108 are further described, for example, at 308 of FIG. 3A.

At 510, one or more buyer devices from the plurality of buyer devices 206 may be selected. In an embodiment, the seller device 116 may select one or more buyer devices from the plurality of buyer devices 206 based on the application of the neural network model 108. For example, the seller device 116 may determine a suitable buyer device based on the structural features and the functional features of the first vehicle 110A, which complies with the compliance requirement for the first geolocation 112A of the buyer device 114. Details of the selection of the buyer device (such as the buyer device 114) are further described, for example, at 322 of FIG. 3B.

At 512, the seller notification may be generated. In an embodiment, the seller device 116 may generate the seller notification based on the selection of the one or more buyer devices. In an example, the seller device 116 may generate the notification for each selected buyer (such as the buyer 124) of the plurality of buyers associated with the plurality of buyer devices 206. Details of the generation of the seller notification are further described, for example, at 324 of FIG. 3B. In some embodiments, the seller device 116 may generate the seller notification directly based on the application of the neural network model 108 (without the selection of one or more buyer devices). In such case, the seller notification may indicate a list of the plurality of buyer devices 206 (or information about the plurality of buyers) and information indicating whether the vehicle (to be sold by the seller 126) does comply (or does not comply) with the requirement for each of the plurality of geolocations 112 of the plurality of buyer devices 206. In certain embodiments, the seller notification may indicate the requirement for at least one the set of features of the first vehicle 110A (to be sold by the seller 126) one or more geolocations of the plurality of buyer devices 206. For example, the seller notification may indicate that an emission test requirement has to be fulfilled for a geolocation of a first buyer and a bill of sale requirement has to be fulfilled for geolocation of a second buyer of the plurality of buyers.

At 514, the seller notification may be rendered on the output device 118. In an embodiment, the seller device 116 may control the output device 118 to render the generated seller notification. In some instances, the rendered seller notification may be displayed in the display device. For example, if the display device is associated with the seller device 116 of the seller 126, the notification may be rendered as “Hello Seller, the vehicle you are intending to sell may require an emission test at the buyer's location”. OR “Hello Seller, the vehicle you are intending to sell may NOT require an emission test at the buyer's location” based on the determination of the compliance requirement, as shown in FIG. 2. Details of rendering of the seller notification are further described, for example, at 326 of FIG. 3B.

The process pipeline shown in FIG. 5 is illustrated as discrete operations from 502-516, which may relate to execution of the vehicle transaction, via the seller device 116, and corresponding generation of the notification associated with the compliance requirement during the sale of the vehicle (such as the first vehicle 110A), via the seller device 116. However, in certain embodiments, such discrete operations may be further divided into additional operations, combined into fewer operations, or eliminated, depending on a particular implementation without detracting from the essence of the disclosed embodiments.

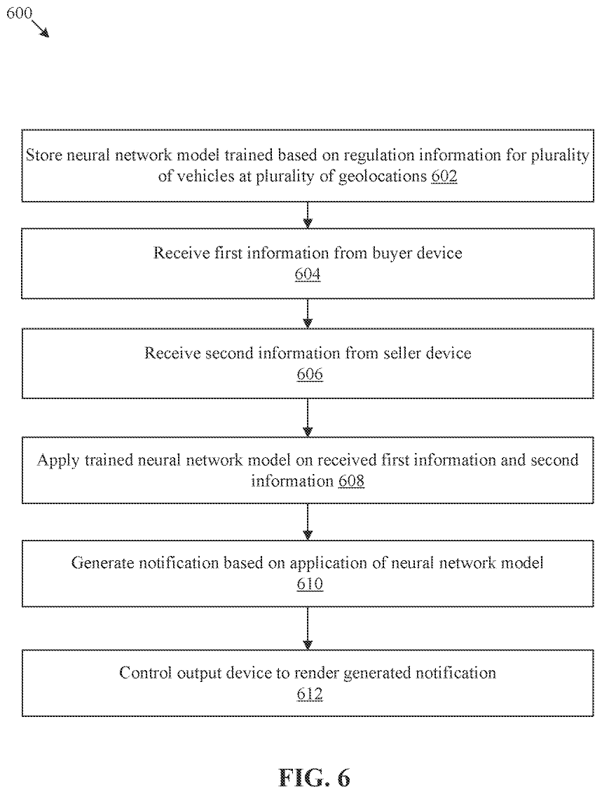

FIG. 6 is a flowchart that illustrates exemplary operations to perform vehicle transactions, in accordance with an embodiment of the disclosure. The flowchart 600 is described in conjunction with FIGS. 1, 2, 3, 4, and 5. The operations from 602 to 612 may be implemented, for example, by the electronic device 102 of FIG. 1. The operations of the flowchart 600 may start at 602.

At 602, the neural network model 108 may be stored. The neural network model 108 may be trained based on the regulation information 108A for a plurality of vehicles 110 at plurality of geolocations 112. In an embodiment, the electronic device 102 may store the neural network model 108. Details about the neural network model 108 are described further, for example, at 302 of FIG. 3A.

At 604, the first information 114A may be received from the buyer device 114. In an embodiment, the electronic device 102 may receive the first information 114A from the buyer device 114. Details about the first information 114A are described further, for example, at 304 of FIG. 3A.

At 606, the second information 116A may be received from the seller device 116. In an embodiment, the electronic device 102 may receive the second information 116A from the seller device 116. Details about the second information 116A are described further, for example, at 306 of FIG. 3A.

At 608, the trained neural network model 108 may be applied on the received first information 114A and the second information 116A. In an embodiment, the electronic device 102 may apply the trained neural network model 108 on the received first information 114A and the second information 116A. Details about the application of the neural network model 108 are described further, for example, at 308 of FIG. 3A.

At 610, the notification may be generated based on the application of the neural network model 108. In an embodiment, the electronic device 102 may generate the notification (like seller notification or buyer notification) based on the application of the neural network model 108. Details of the generation of the notification are described further, for example, at 310 of FIG. 3A.

At 612, the generated notification may be rendered via the output device 118. In an embodiment, the electronic device 102 may control the output device 118 to render the generated notification. Details of the rendering of the generated notification via the output device 118 are described further, for example, at 312 of FIG. 3A.

The flow chart shown in FIG. 6 is illustrated as discrete operations, such as from 602 to 612, which relates to the generation of the notification associated with the compliance during the purchase and/or selling of the vehicle (such as the first vehicle 110A), via at least one of: the electronic device 102, the buyer device 114, or the seller device 116. However, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of instructions executable by a machine and/or a computer (for example, the electronic device 102) for the generation of the notification associated with the compliance during the purchase and/or selling of the vehicle (such as the first vehicle 110A). The set of instructions may be executable by the machine and/or the computer (for example the electronic device 102) to perform specific operations. The operations may include storage of the neural network model 108 which has been trained with regulation information for the plurality of vehicles 110 at the plurality of geolocations 112, reception of the first information from the buyer device 114, reception of the second information from the seller device 116, application of the trained neural network model 108 on the received first information and the second information to determine whether the set of features of the first vehicle 110A complies with the requirement of the first vehicle 110A for the first geolocation 112A of the buyer device 114, generation of the notification based on the application of the neural network model 108, and control of the output device 118 to render the generated notification.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that includes a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which includes all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments that fall within the scope of the appended claims.

What is claimed is:

1. An electronic device, comprising:
a memory configured to store a neural network model trained based on regulation information for a plurality of vehicles at a plurality of geolocations, wherein the regulation information corresponds to a requirement of each of a plurality of features of the plurality of vehicles to operate in one or more geolocations of the plurality of geolocations; and
at least one processor configured to:
receive first information from a buyer device, wherein the first information corresponds to a vehicle to be purchased for a first geolocation of the buyer device,
receive second information from a seller device, wherein the second information corresponds to a set of features of the vehicle to be sold by a seller of the seller device which is located at a second geolocation, the second geolocation of the seller device and the vehicle is different from the first geolocation,
apply the trained neural network model on the received first information and the second information to determine whether the set of features of the vehicle complies with the requirement of the vehicle for the first geolocation of the buyer device,
generate a notification based on the application of the neural network model, wherein the generated notification indicates the requirement for at least one of the set of features for the first geolocation, and
control an output device to render the generated notification.

2. The electronic device according to claim 1, wherein the first information further corresponds to a first feature of the vehicle to be purchased, wherein the processor is further configured to:
apply the trained neural network model on the received first information and the second information to determine whether the corresponding feature from the set of features of the vehicle complies with the requirement of the first feature of the vehicle for the first geolocation of the buyer device;
generate the notification based on the application of the neural network model, wherein the generated notification indicates the requirement for the at least one of the set of features for the first geolocation; and
control the output device to render the generated notification.

3. The electronic device according to claim 1, wherein
the requirement for each of the set of features for the vehicle is related to at least one of: a structural feature requirement of the vehicle or a functional feature requirement of the vehicle, which is required for the vehicle to operate in the first geolocation of the buyer device.

4. The electronic device according to claim 1, wherein the at least one processor is further configured to:
receive third information from a plurality of buyer devices, wherein the third information corresponds to the vehicle to be purchased for a plurality of geolocations of the plurality of buyer devices;
apply the trained neural network model on the received third information and the second information to determine whether the set of features of the vehicle complies with the requirement of the vehicle for the plurality of geolocations of the plurality of buyer devices;
select one or more buyer devices from the plurality of buyer devices, based on the application of the neural network model;
generate a seller notification based on the selection of the one or more buyer devices; and
control the output device to render the generated seller notification.

5. The electronic device according to claim 1, wherein the at least one processor is further configured to:
receive fourth information from a plurality of seller devices, wherein the fourth information corresponds to the set of features of each of a set of vehicles to be sold by a plurality of sellers related to the plurality of seller devices and wherein geolocations of the plurality of seller devices and the set of vehicles are different from the first geolocation;
apply the trained neural network model on the received first information and the fourth information to determine whether the set of features of the set of vehicles complies with the requirement of the vehicle for the first geolocation of the buyer device;
select one or more seller devices from the plurality of seller devices, based on the application of the neural network model;
generate a buyer notification based on the selection of the one or more seller devices; and
control the output device to render the generated buyer notification.

6. The electronic device according to claim 1, wherein the at least one processor is further configured to:
receive fourth information from a plurality of seller devices, wherein the fourth information indicates to a level of damage in a set of vehicles to be sold by a plurality of sellers related to the plurality of seller devices, and wherein the level of damage is determined based on at least one of: registration information of the set of vehicles, or a visual inspection information of the set of vehicles;
apply the trained neural network model on the received first information and the fourth information to determine whether the level of damage related to the set of features of the set of vehicles complies with the requirement of the vehicle for the first geolocation of the buyer device;
select one or more seller devices from the plurality of seller devices, based on the application of the neural network model;
generate a buyer notification based on the selection of the one or more seller devices; and
control the output device to render the generated buyer notification.

7. The electronic device according to claim 1, wherein the at least one processor is further configured to:
receive fourth information from a plurality of seller devices, wherein the fourth information indicates to a service history of a set of vehicles to be sold by a plurality of sellers related to the plurality of seller devices, and wherein the service history is determined based on at least one of: a number of repairs, or a number of accidents of the set of vehicles;
apply the trained neural network model on the received first information and the fourth information to determine whether the service history related to the set of features of the set of vehicles complies with the requirement of the vehicle for the first geolocation of the buyer device;
select one or more potential seller devices from the plurality of seller devices, based on the application of the neural network model;
generate a buyer notification based on the selection of the one or more seller devices; and
control the output device to render the generated buyer notification.

8. The electronic device according to claim 1, wherein the at least one processor is further configured to:
receive fourth information from a plurality of seller devices, wherein the fourth information corresponds to at least one of: a need for sale for a set of vehicles to be sold by a plurality of sellers related to the plurality of seller devices, or a fit for sale certificate received from a regulatory authority for the set of vehicles;
apply the trained neural network model on the received first information and the fourth information to determine whether the fourth information for the set of vehicles complies with the requirement of the vehicle for the first geolocation of the buyer device;
select one or more seller devices from the plurality of seller devices, based on the application of the neural network model;
generate a buyer notification based on the selection of the one or more seller devices; and
control the output device to render the generated buyer notification.

9. The electronic device according to claim 1,
wherein the notification indicates information associated with a compliance of the vehicle with the requirement of the vehicle for the first geolocation of the buyer device.

10. The electronic device according to claim 1,
wherein the notification corresponds to information associated with a nearest regulatory authority at the first geolocation of the buyer device, to regulate the vehicle in accordance with the requirement for the vehicle to be operated at the first geolocation of the buyer device.

11. The electronic device according to claim 10,
wherein the notification further corresponds to information related to at least one of: a cost or a validity period, for the vehicle to meet the requirement at the first geolocation of the buyer device, via the regulatory authority.

12. The electronic device according to claim 1, wherein the output device is associated with at least one of: the buyer device or the seller device.

13. The electronic device according to claim 1,
wherein the notification is at least one of: a visual notification, an audible notification, an audio-visual notification, or a tactile notification.

14. The electronic device according to claim 1,
wherein the second information is authenticated based on license information of the seller device, and registration information of the vehicle to be sold by the seller of the seller device.

15. A seller device, comprising:
a memory configured to store a neural network model trained based on regulation information for a plurality of vehicles at a plurality of geolocations, wherein the regulation information corresponds to a requirement of each of a plurality of features of the plurality of vehicles to operate in one or more geolocations of the plurality of geolocations; and
at least one processor configured to:
receive first information from a plurality of buyer devices, wherein the first information corresponds to a vehicle to be purchased for a plurality of geolocations of the plurality of buyer devices,
acquire second information associated with the seller device, wherein the second information corresponds to a set of features of the vehicle to be sold by a seller of the seller device which is located at a second geolocation, the second geolocation of the seller device and the vehicle is different from the plurality of geolocations of the plurality of buyer devices,
apply the trained neural network model on the received first information and the acquired second information to determine whether the set of features of the vehicle complies with the requirement of the vehicle for the plurality of geolocations of the plurality of buyer devices,
generate a seller notification based on the application of the neural network model, wherein the generated seller notification indicates the requirement for at least one of the set of features for each of the plurality of geolocations related to corresponding buyer device of the plurality of buyer devices, and
control an output device to render the generated seller notification.

16. The seller device according to claim 15, wherein the at least one processor is further configured to:
select one or more buyer devices from the plurality of buyer devices, based on the application of the neural network model;
generate the seller notification based on the selection of the one or more buyer devices; and
control the output device to render the generated seller notification.

17. The seller device according to claim 15, wherein the requirement for each of the set of features for the vehicle is related to at least one of: a structural feature requirement of the vehicle or a functional feature requirement of the vehicle, which is required for the vehicle to operate in the plurality of geolocations of the plurality of buyer devices.

18. A buyer device, comprising:
a memory configured to store a neural network model trained based on regulation information for a plurality of vehicles at a plurality of geolocations, wherein the regulation information corresponds to a requirement of each of a plurality of features of the plurality of vehicles to operate in one or more geolocations of the plurality of geolocations; and
at least one processor configured to:
acquire first information associated with the buyer device, wherein the first information corresponds to a vehicle to be purchased for a first geolocation of the buyer device,
receive second information from a plurality of seller devices, wherein the second information corresponds to a set of features of each of a set of vehicles to be sold by a plurality of sellers related to the plurality of seller devices, and wherein geolocations of the plurality of seller devices and the set of vehicles are different from the first geolocation,
apply the neural network model on the acquired first information and the received second information to determine whether the set of features of the set of vehicles complies with the requirement of the vehicle for the first geolocation of the buyer device,
generate a buyer notification based on the application of the neural network model, wherein the generated buyer notification indicates the requirement for at least one of the set of features for the first geolocation; and
control an output device to render the generated buyer notification.

19. The buyer device according to claim 18, wherein the at least one processor is further configured to:
select one or more seller devices from the plurality of seller devices, based on the application of the neural network model;
generate the buyer notification based on the selection of the one or more seller devices; and
control the output device to render the generated buyer notification.

20. The buyer device according to claim 18, wherein
the requirement for each of the set of features for the vehicle is related to at least one of: a structural feature requirement of the vehicle or a functional feature requirement of the vehicle, which is required for the vehicle to operate in the first geolocation of the buyer device.
